(19) United States
(12) Patent Application Publication
(10) Pub. No.: US 2026/0165224 A1
(43) Pub. Date: Jun. 18, 2026

(54) WORKING VEHICLE

(71) Applicant: Kubota Corporation, Osaka (JP)

(72) Inventors: Shotaro KAWAHATA, Fremont, CA (US); Hiroaki HOSOZAWA, Fremont, CA (US)

(21) Appl. No.: 19/385,477

(22) Filed: Nov. 11, 2025

Related U.S. Application Data
(60) Provisional application No. 63/733,627, filed on Dec. 13, 2024.

(51) Int. Cl. A01B 69/04; G05D 1/229; G05D 1/248; G05D 1/648; G05D 1/65

(52) U.S. Cl. CPC A01B 69/008; G05D 1/2295; G05D 1/248; G05D 1/6484; G05D 1/65

(57) ABSTRACT

A working vehicle includes an electric motor in or on a vehicle body, a traveling device to be driven by power from the electric motor to cause the vehicle body to travel, a first input interface to receive input of status information indicating a state of at least one of the working vehicle or a surrounding environment of the working vehicle, and a controller configured or programmed to determine, based on the status information, a duration of a forward/rearward travel switching action to change a direction of travel of the vehicle body from forward to rearward or from rearward to forward, and control driving of the electric motor to perform, via the traveling device, the forward/rearward travel switching action over the determined duration.

### CROSS-REFERENCE TO RELATED APPLICATIONS

This application claims the benefit of priority to U.S. Provisional Patent Application No. 63/733,627 filed on Dec. 13, 2024. The entire contents of this application are hereby incorporated herein by reference.

### BACKGROUND OF THE INVENTION

### 1. Field of the Invention

The present invention relates to techniques to switch directions of travel between forward and backward of working vehicles operable to travel using power from electric motors.

### 2. Description of the Related Art

Working vehicles powered by an electric motor to travel include, for example, an electric working vehicle disclosed in Japanese Unexamined Patent Application Publication No. 2024-97964. The electric working vehicle includes an electric motor mounted on a vehicle body, a traveling device to cause the vehicle body to travel, and a controller to control the rotation of the electric motor, in which wheels included in the traveling device rotate using the power from the electric motor to cause the vehicle body to travel.

On the other hand, a working vehicle powered by an engine to travel is disclosed in, for example, Japanese Unexamined Patent Application Publication No. 2024-73225. With the working vehicle, according to the vehicle speed at the time when a forward/rearward travel switching lever is operated, the speed stage of the transmission and the operation of the forward/reverse clutch are controlled, and the switching of the direction of travel of the vehicle body between forward and rearward is permitted or restrained.

With regard to working vehicles powered by an electric motor to travel, the direction of travel of the working vehicle can be switched between forward and rearward more easily and quickly than working vehicles powered by an engine to travel, by controlling the direction of rotation of the electric motor. However, it is desirable to control the rapidity of the action to switch the direction of travel between forward and rearward in order to, for example, stabilize the vehicle body. Therefore, example embodiments of the present invention make it possible to control the rapidity of the action to switch the direction of travel of the working vehicle between forward and rearward.

### SUMMARY OF THE INVENTION

A working vehicle according to an example embodiment of the present invention includes an electric motor in or on a vehicle body, a traveling device to be driven by power from the electric motor to cause the vehicle body to travel, a first input interface to receive input of status information indicating a state of at least one of the working vehicle or a surrounding environment of the working vehicle, and a controller configured or programmed to determine, based on the status information, a duration of a forward/rearward travel switching action to change a direction of travel of the vehicle body from forward to rearward or from rearward to forward, and control driving of the electric motor and perform, via the traveling device, the forward/rearward travel switching action over the determined duration.

In an example embodiment of the present invention, the working vehicle may further include an inverter to drive the electric motor. The controller may be configured or programmed to, while the vehicle body is traveling or is in a stopped state, determine the duration based on the status information inputted via the first input interface, and cause the inverter to control a rotation speed and a rotation direction of the electric motor, and perform the forward/rearward travel switching action over the determined duration.

In an example embodiment of the present invention, the working vehicle may further include a second input interface to receive input of an instruction to perform the forward/rearward travel switching action. The controller may be configured or programmed to, upon receipt of input of the instruction, determine the duration based on the status information inputted via the first input interface, and perform the forward/rearward travel switching action over the determined duration.

In an example embodiment of the present invention the controller may be configured or programmed to determine a point in time at which the forward/rearward travel switching action is to be performed based on the state of the at least one of the working vehicle or the surrounding environment of the working vehicle indicated by the status information, and, at the determined point in time, determine the duration, and perform the forward/rearward travel switching action over the determined duration.

In an example embodiment of the present invention, the first input interface may include at least one of a user interface to receive input of vehicle information indicating whether or not the working vehicle is an unmanned working vehicle, a communicator to receive the vehicle information, or a first sensor to detect whether a person is in the working vehicle. The working vehicle may further include at least one of a memory or a storage to store the vehicle information. The controller may be configured or programmed to determine whether or not a person is in the working vehicle based on at least one of the vehicle information or a detected result from the first sensor, and determine the duration such that the duration is shorter when it is determined that no persons are in the working vehicle than when it is determined that a person is in the working vehicle.

In an example embodiment of the present invention, the first input interface may include at least one of a second sensor to detect at least one of a steering angle of the vehicle body or a yaw angle of the vehicle body, or a position detector to detect a position thereof using a satellite positioning system. The controller may be configured or programmed to determine whether the vehicle body is traveling straight or turning based on at least one of a detected result from the second sensor or time-series data about the position detected by the position detector, and determine the duration such that the duration is shorter when it is determined that the vehicle body is traveling straight than when it is determined that the vehicle body is turning.

In an example embodiment of the present invention, the first input interface may include at least one of a user interface to receive input of device information relating to a working device linked to the vehicle body to perform work, a communicator to receive the device information, or a third sensor to detect the working device linked to the vehicle body. The working vehicle may further include at least one of a memory or a storage to store the device information. The controller may be configured or programmed to determine whether or not the working device is linked to the vehicle body based on at least one of a detected result from the third sensor or the device information, and determine the duration such that the duration is shorter when it is determined that no working devices are linked to the vehicle body than when it is determined that the working device is linked to the vehicle body.

In an example embodiment of the present invention, the first input interface may include at least one of a user interface to receive input of device information relating to a working device linked to the vehicle body to perform work, a communicator to receive the device information, or a third sensor to detect the working device linked to the vehicle body. The working vehicle may further include at least one of a memory or a storage to store the device information. The controller may be configured or programmed to determine a type of the working device liked to the vehicle body based on at least one of a detected result from the third sensor or the device information, and determine the duration based on the type of the working device.

In an example embodiment of the present invention, the controller may be configured or programmed to determine whether the type of the working device is a directly attached working device supported by the vehicle body or a towed working device towed by the vehicle body based on at least one of the detected result from the third sensor or the device information, and determine the duration such that the duration is shorter when it is determined that the type of the working device is a directly attached working device than when it is determined that the type of the working device is a towed working device.

In an example embodiment of the present invention, the controller may be configured or programmed to determine whether the type of the working device is a lightweight working device having a weight less than a threshold or a heavyweight working device having a weight equal to or more than the threshold based on at least one of the detected result from the third sensor or the device information, and determine the duration such that the duration is shorter when it is determined that the type of the working device is a lightweight working device than when it is determined that the type of the working device is a heavyweight working device.

In an example embodiment of the present invention, the controller may be configured or programmed to determine whether the working device is linked to a front portion of the vehicle body or a rear portion of the vehicle body based on at least one of the detected result from the third sensor or the device information, and determine the duration such that the duration is shorter when it is determined that the working device is linked to the front portion of the vehicle body than when it is determined that the working device is linked to the rear portion of the vehicle body.

In an example embodiment of the present invention, the first input interface may include at least one of a fourth sensor to detect a pitch angle of the vehicle body, a fifth sensor to detect a slope condition of a ground on which the vehicle body is located, or a communicator to receive map information including a geographical feature of a location where the vehicle body travels. The first input interface may further include a position detector to detect a position thereof using a satellite positioning system. The working vehicle may further include at least one of a memory or a storage to store the map information. The controller may be configured or programmed to determine at least one of a geographical feature or a size of a location where the vehicle body is located based on at least one of a detected result from the fourth sensor, a detected result from the fifth sensor, or a result of comparison between the map information and the position detected by the position detector, and determine the duration based on the determined at least one of the geographical feature or the size of the location.

In an example embodiment of the present invention, the controller may be configured or programmed to determine whether the vehicle body is traveling on a level ground or a sloping ground based on at least one of the detected result from the fourth sensor, the detected result from the fifth sensor, or the result of comparison, and determine the duration such that the duration is shorter when it is determined that the vehicle body is traveling on a level ground than when it is determined that the vehicle body is traveling on a sloping ground.

In an example embodiment of the present invention, the controller may be configured or programmed to determine whether the vehicle body is traveling up or down a sloping ground based on at least one of the detected result from the fourth sensor, the detected result from the fifth sensor, or the result of comparison, and determine the duration such that the duration is longer when it is determined that the vehicle body is traveling up a sloping ground than when it is determined that the vehicle body is traveling down a sloping ground.

In an example embodiment of the present invention, the controller may be configured or programmed to determine whether the vehicle body is traveling on a level ground or traveling up a sloping ground based on at least one of the detected result from the fourth sensor, the detected result from the fifth sensor, or the result of comparison, and determine the duration such that the duration is shorter when it is determined that the vehicle body is traveling on a level ground than when it is determined that the vehicle body is traveling up a sloping ground.

In an example embodiment of the present invention, the first input interface may include at least one of a user interface to receive input of agricultural field information relating to an agricultural field, or a communicator to receive the agricultural field information. The first input interface may further include a position detector to detect a position thereof using a satellite positioning system. The working vehicle may further include at least one of a memory or a storage to store the agricultural field information. The controller may be configured or programmed to in a case that the position detected by the position detector is in a headland located between a work area of the agricultural field and an edge of the agricultural field indicated by the agricultural field information included in the status information, calculate a headland width which is a distance from the work area to the edge, and determine the duration such that the duration is longer when the headland width is less than a predetermined value than when the headland width is equal to or more than the predetermined value.

In an example embodiment of the present invention, the controller may be configured or programmed to determine whether or not a predetermined condition is satisfied based on the status information, and determine a related value for use in determining the duration that is a first value or a second value depending on whether or not the predetermined condition is satisfied, the second value being a value that makes the duration longer than the first value.

In an example embodiment of the present invention, the controller may be configured or programmed to determine whether or not a plurality of the predetermined conditions are satisfied based on a plurality of pieces of the status information, and provisionally determine, depending on whether or not the plurality of predetermined conditions are satisfied, a respective plurality of the related values each of which is the first value or the second value, and, in a case that the provisionally determined plurality of related values include one or more instances of the first value and one or more instances of the second value, determine that the first value or the second value a number of the included instances of which is more than the other is a definitively determined related value.

In an example embodiment of the present invention, the controller may be configured or programmed to determine whether or not a plurality of the predetermined conditions are satisfied based on a plurality of pieces of the status information, and provisionally determine, depending on whether or not the plurality of predetermined conditions are satisfied, a respective plurality of the related values each of which is the first value or the second value, in a case that each of the provisionally determined plurality of related values is the first value, determine that the first value is a definitively determined related value, and in a case that the provisionally determined plurality of related values include one or more instances of the first value and one or more instances of the second value, determine that the second value is a definitively determined related value.

In an example embodiment of the present invention, the controller may be configured or programmed to determine whether or not a plurality of the predetermined conditions are satisfied based on a plurality of pieces of the status information, and provisionally determine, depending on whether or not the plurality of predetermined conditions are satisfied, a plurality of the related values each of which is the first value or the second value, assign N points to each of the plurality of related values that has been provisionally determined based on a dynamic condition included in the plurality of predetermined conditions, whether the dynamic condition is satisfied being variable during travel of the vehicle body, assign M points to each of the plurality of related values that has been provisionally determined based on a static condition included in the plurality of predetermined conditions, whether the static condition is satisfied being not variable during travel of the vehicle body, where M is less than N, and, in a case that the provisionally determined plurality of related values include one or more instances of the first value and one or more instances of the second value, calculate a total number of points assigned to the one or more included instances of the first value and a total number of points assigned to the one or more included instances of the second value, and determine that the first value or the second value the total number of points of which is more than the other is a definitively determined related value.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a side view of an example of a working vehicle.

FIG. 2 is a side view of another example of a working vehicle.

FIG. 3 is a block diagram illustrating a configuration of an example of a system included in a working vehicle.

FIG. 4 schematically illustrates an example of devices relating to travel and steering of a working vehicle.

FIG. 5 illustrates an example of an agricultural field and a travel route defined in the agricultural field.

FIG. 6A is a graph showing an example of forward/rearward travel switching characteristics for switching from forward travel to rearward travel.

FIG. 6B is a graph showing an example of forward/rearward travel switching characteristics for switching from rearward travel to forward travel.

FIG. 7A is a graph showing an example of forward/rearward travel switching characteristics for switching from forward travel to rearward travel in the case of a stopped state.

FIG. 7B is a graph showing an example of forward/rearward travel switching characteristics for switching from rearward travel to forward travel in the case of a stopped state.

FIG. 8 shows graphs showing other examples of forward/rearward travel switching characteristics.

FIG. 9A is a graph showing another example of forward/rearward travel switching characteristics for switching from forward travel to rearward travel.

FIG. 9B is a graph showing another example of forward/rearward travel switching characteristics for switching from forward travel to rearward travel.

FIG. 9C is a graph showing another example of forward/rearward travel switching characteristics for switching from rearward travel to forward travel.

FIG. 9D is a graph showing another example of forward/rearward travel switching characteristics for switching from rearward travel to forward travel.

FIG. 10A shows graphs showing other examples of forward/rearward travel switching characteristics for switching from forward travel to rearward travel.

FIG. 10B shows graphs showing other examples of forward/rearward travel switching characteristics for switching from rearward travel to forward travel.

FIG. 11 shows graphs showing other examples of forward/rearward travel switching characteristics for a working vehicle traveling down a slope.

FIG. 12 is a table showing an example of the relationship between a plurality of conditions relating to status information and forward/rearward travel switching characteristics.

FIG. 13 is a table showing another example of the relationship between a plurality of conditions relating to status information and forward/rearward travel switching characteristics.

FIG. 14 is a list showing an example of a settings screen for forward/rearward travel switching characteristics.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

The following description discusses example embodiments of the present invention with reference to drawings as necessary.

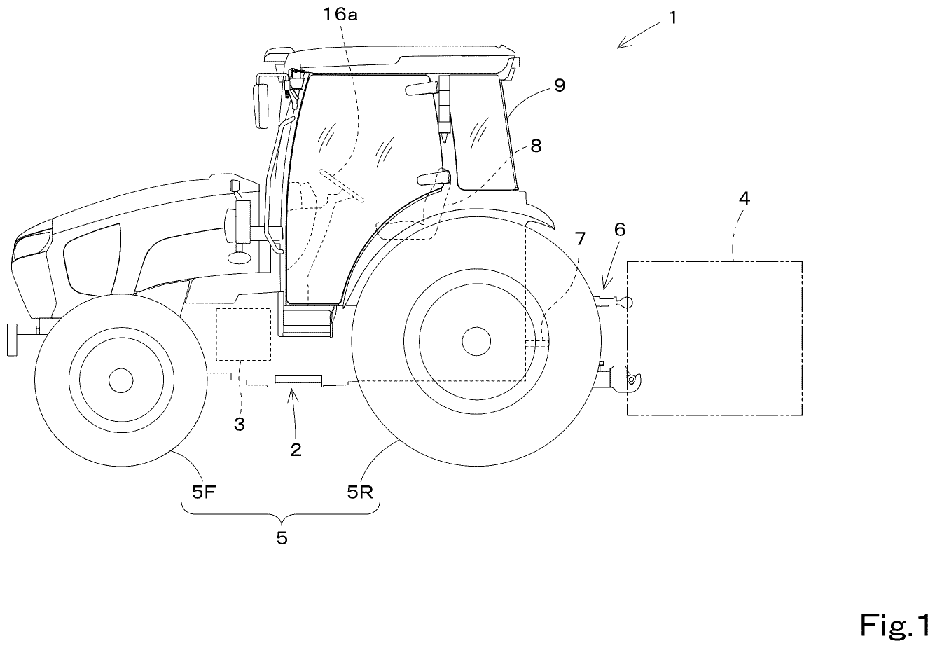

FIG. 1 is a side view of an example of a working vehicle 1. In the present example embodiment, a tractor is illustrated as an example of the working vehicle 1. However, the working vehicle according to example embodiments of the present invention is not limited to a tractor, but may be some other agricultural machine, a construction machine, some other working vehicle or the like. As viewed from a person looking at FIG. 1, the left, right, near, and far sides in FIG. 1 are the front, rear, left, and right of the working vehicle 1, respectively. The direction perpendicular to a front-rear direction and an up-down direction of the working vehicle 1 is hereinafter referred to as a machine body wide direction.

The working vehicle 1 includes a vehicle body 2, an electric motor 3, and a traveling device 5. The vehicle body 2 has thereon or therein the electric motor 3, a cabin 9 and the like. The electric motor 3 is a power source for the working vehicle 1 to travel.

Note that the working vehicle 1 includes a power source other than the electric motor 3 for travel. For example, at least one or more of the following power sources may be provided in or on the vehicle body 2: electric motors, batteries, engines, hydraulic pumps, hydraulic motors and the like, as a power source for equipment other than those for travel of the working vehicle 1, for electrical component(s), and/or for a working device 4 connected to the working vehicle 1.

The working vehicle 1 may be an electric working vehicle which includes a motor such as an electric motor as a power source and does not include an internal combustion engine such as an engine, and may be a hybrid working vehicle including an electric motor and an internal combustion engine.

The cabin 9 houses therein a seat 8, various manual operators and the like. Instead of the cabin 9, a protection structure such as a canopy or rollover protection structure (ROPS) may be provided around the seat 8.

The traveling device 5 supports the vehicle body 2 from below such that the vehicle body 2 is allowed to travel. The traveling device 5 is driven by power outputted from the electric motor 3 to cause the vehicle body 2 to travel. In the example illustrated in FIG. 1, the traveling device 5 includes a plurality of wheels 5F, 5R. The plurality of wheels 5F and 5R are spaced apart from each other in the front-rear direction or width direction. Specifically, the plurality of wheels 5F, 5R include a pair of left and right front wheels 5F to support a front portion of the vehicle body 2 and a pair of left and right rear wheels 5R to support a rear portion of the vehicle body 2. The plurality of wheels 5F and 5R are tire wheels, and each include a tire, an annular rim around which the tire is fitted, and a hub located at the center of the tire and attaching the rim to an axle.

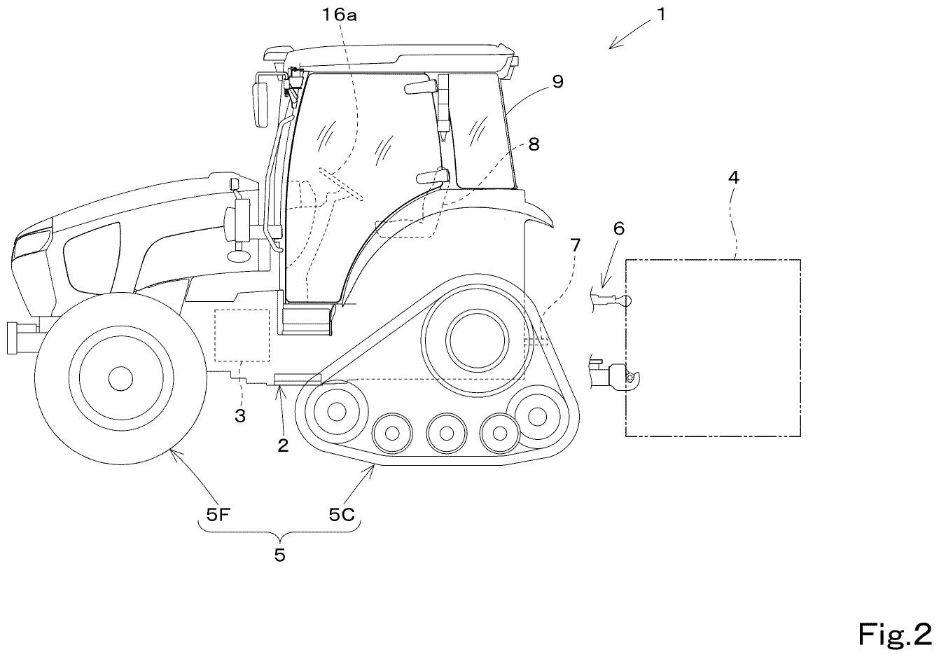

As another example, a traveling device 5 with crawler wheels 5C (continuous tracks), as illustrated in FIG. 2, may be provided at the rear of the working vehicle 1. A pair of the left and right crawler wheels 5C are provided at the rear of the vehicle body 2. Each crawler wheel 5C includes a crawler, a driving wheel to drive the crawler to rotate in a loop, and driven wheels to rotate as the crawler is driven to rotate in a loop. The crawler is, for example, a rubber crawler made of rubber which is an elastic body. In addition, a plurality of track rollers (free rotating wheels) may be included in each crawler wheel 5C.

The working vehicle 1 includes a linkage 6. The linkage 6 is, for example, a linkage (hitch) with a three-point linkage structure provided at a rear portion of the vehicle body 2, and operable to attach and detach thereto and therefrom a working device 4 to perform work. The linkage 6 includes a lifting mechanism to raise and lower the working device 4 connected to the linkage 6, and actuator(s) to actuate the lifting mechanism, such as hydraulic or electric cylinder(s). The working device 4 is connected to the vehicle body 2 (working vehicle 1) via the linkage 6 and operable to be raised and lowered by the linkage 6. In addition to or instead of the linkage 6 which includes a three-point linkage, the working vehicle 1 may include some other linkage 6 such as a drawbar.

The linkage 6 can attach thereto various types of working devices 4. Examples of the working device 4 include tillers (rotary tillers) to till agricultural fields, stubble cultivators, spreaders to spread fertilizer or water, seeders to sow crop seeds or seed potatoes, earthing-up equipment (also called “ridgers”) to perform earthing up, pest controllers to spread chemicals, and harvesters to harvest crops grown in an agricultural field. The working device 4 may be an implement including any of the above devices, or may be an attachment.

Examples of the working device 4 include towed working devices each including wheel(s) and connected to the linkage 6 to be towed by the working vehicle 1, and directly attached working devices each including no wheels and connected to the linkage 6 to be supported by the working vehicle 1 in a floating position off the ground. Examples of the working device 4 also include heavyweight working devices each having a weight equal to or more than a threshold, and lightweight working devices each having a weight less than the threshold. Examples of the working device 4 also include working devices each including a drive to be driven by power transmitted from the working vehicle 1 via the PTO shaft 7, and working devices without the drive. Examples of the working devices 4 also include working devices each including an electronic controller including a CPU, and working devices without the electronic controller. Various types of the working devices 4, in addition to those listed above, can be connected to the vehicle body 2 (working vehicle 1) via the linkage 6.

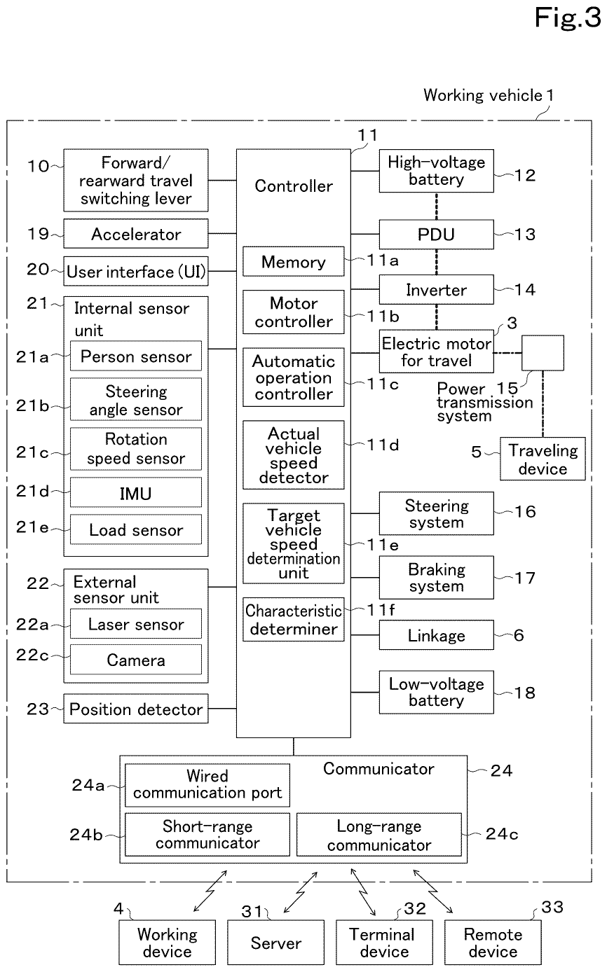

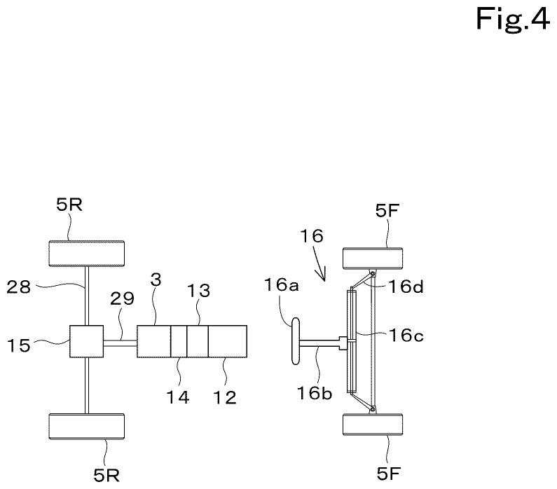

FIG. 3 is a block diagram illustrating an example of a system included in the working vehicle 1. Specifically, the system illustrated in FIG. 3 is a forward/rearward travel switching system to switch the direction of travel the working vehicle 1 between forward and rearward. FIG. 4 schematically illustrates an example of devices relating to travel and steering of the working vehicle 1.

As illustrated in FIG. 3, the working vehicle 1 includes, in addition to the travel electric motor 3, the traveling device(s) 5, and the linkage 6 which are described earlier, a controller 11, a high-voltage battery 12, a power distribution unit (electricity distribution unit, PDU) 13, an inverter 14, a power transmission system 15, a steering system 16, a braking system 17, a low-voltage battery 18, a forward/rearward travel switching lever 10, an accelerator (so-called gas pedal, acceleration device) 19, a user interface (in FIG. 3, denoted as “UI) 20, an internal sensor unit 21, an external sensor unit 22, a position detector 23, and a communicator 24.

The controller 11 includes a vehicle control unit (VCU) or a computer including processor(s) such as CPU and a memory (memories) 11a. The controller 11 is configured or programmed to control the operation of elements of the working vehicle 1. The memory 11a is a storing device to store various types of information, and includes volatile and nonvolatile memories. The memory 11a stores various information and data that the controller 11 can read and write to control the operation of elements. In addition to or instead of the memory 11a, the working vehicle 1 may include a storing device (memory and/or storage) including a memory drive, such as a solid state drive (SSD), for example.

The controller 11 is configured or programmed to include a motor controller 11b, an automatic operation controller 11c, an actual vehicle speed detector 11d, a target vehicle speed determiner 11e, and a characteristics determiner 11f. The motor controller 11b, the automatic operation controller 11c, the actual vehicle speed detector 11d, the target vehicle speed determiner 11e, and the characteristics determiner 11f each include software program(s) or hardware.

The high-voltage battery 12 is a storage battery to store high-voltage electricity and is a source of electricity for the working vehicle 1 to travel. The PDU 13 includes a switching circuit to switch devices to which the electricity is outputted. The inverter 14 is a driver including a drive circuit to drive the electric motor 3. The inverter 14 supplies electricity outputted from the high-voltage battery 12 via the PDU 13 to the electric motor 3 to drive the electric motor 3 to rotate.

The power transmission system 15 is a differential to transmit power outputted from the electric motor 3 to the traveling device 5. Specifically, as illustrated in FIG. 4, for example, the power transmission system 15 transmits, to a pair of rear wheels 5R (5C) which are the driving wheels of the wheels 5F, 5R (5C) of the traveling device 5 via the drive shaft 28, a rotary driving force transmitted from the electric motor 3 via a propeller shaft 29. This rotates and drives the pair of rear wheels 5R (5C), which in turn rotates and drives the pair of front wheels 5F which are driven wheels. Note that the power transmission system 15 may include a transmission to change the speed stage of the vehicle speed of the working vehicle 1 steplessly.

As another example, of the plurality of wheels 5F, 5R (5C) of the traveling device 5, the pair of front wheels 5F may be driving wheels and the pair of rear wheels 5R (5C) may be driven wheels. In such a case, the power transmission system 15 need only be configured to transmit power outputted from the electric motor 3 to the pair of front wheels 5F. Alternatively, the power transmission system 15 may be configured to switch between a two-wheel drive state in which power is transmitted to either the pair of front wheels 5F or the pair of rear wheels 5R (5C) and a four-wheel drive state in which power is transmitted to all the wheels 5F and 5R (5C).

The electric motor 3 includes a motor/generator. The electric motor 3 outputs power to the traveling device 5 via the power transmission system 15, and, when, for example, the working vehicle 1 decreases in speed, the electric motor 3 generates electricity by performing regenerative operation using the rotary driving force inputted from the traveling device 5 via the power transmission system 15. The electricity generated by the electric motor 3 is inputted into the high-voltage the battery 12 via the inverter 14 and the PDU 13. That is, the high-voltage battery 12 is charged with electricity generated by the electric motor 3.

The motor controller 11b (FIG. 3) of the controller 11 detects the discharged state, the charged state, the amount of stored electricity, and/or the like of the high-voltage battery 12. The motor controller 11b controls the operation of the PDU 13 to cause the high-voltage battery 12 to discharge electricity (electric current) to supply the electricity to the inverter 14, and cause the electricity generated by the electric motor 3 to be supplied from the inverter 14 to the high-voltage battery 12 to store (charge) the electricity in the high-voltage battery 12.

The motor controller 11b controls the operation of the inverter 14 to supply electric current to the electric motor 3 to be driven to rotate. The motor controller 11b controls the rotation speed and the direction of rotation of the electric motor 3 by changing the magnitude of electric current supplied to the electric motor 3 by the inverter 14 and the direction of supply of the electric current. As the rotation speed of the electric motor 3 changes, the rotation speed of the wheels 5F and 5R (5C) of the traveling device 5 also changes, and the vehicle speed (travel speed) of the vehicle body 2 and the working vehicle 1 changes. The electric motor 3 is driven to rotate in a forward direction to rotate the wheels 5F, 5R (5C) in a forward direction, causing the traveling device 5 and the vehicle body 2 to travel forward and the working vehicle 1 to also travel forward. The electric motor 3 is driven to rotate in a reverse direction to rotate the wheels 5F, 5R (5C) in a reverse direction, causing the traveling device 5 and the vehicle body 2 to travel rearward and the working vehicle 1 to also ravel rearward.

The controller 11 causes the motor controller 11b to control the electric motor 3 and the traveling device 5 via the inverter 14 to cause the vehicle body 2 (working vehicle 1) to travel, change the vehicle speed of the vehicle body 2 (working vehicle 1), and change the direction of travel of the vehicle body 2 (working vehicle 1). More specifically, the controller 11 causes the motor controller 11b to control (change) the rotation speed of the electric motor 3 via the inverter 14 to also control (change) the rotation speed of the wheels 5F, 5R (5C) of the traveling device 5 to increase the vehicle speed (increase the speed) or reduce the vehicle speed (reduce the speed) of the vehicle body 2 and the working vehicle 1. The controller 11 causes the motor controller 11b to control the direction of rotation of the electric motor 3 via the inverter 14 to also control the direction of rotation of the wheels 5F and 5R (5C) to perform a forward/rearward travel switching action to switch the forward-traveling state of the vehicle body 2 and the working vehicle 1 to the rearward-traveling state or switch the rearward-traveling state of the vehicle body 2 and the working vehicle 1 to the forward-traveling state.

Note that, in the present example embodiment, the driving source for the working vehicle 1 to travel is a single electric motor 3, but the working vehicle 1 may include a plurality of electric motors as driving sources. For example, the working vehicle 1 may include a front electric motor to rotate and drive the pair of left and right front wheels 5F and a rear electric motor to rotate and drive the pair of left and right rear wheels 5R (or wheels 5C). Alternatively, the working vehicle 1 may include a left electric motor to rotate and drive driving wheel(s) which is/are at least one of the front wheel 5F or the rear wheel 5R (or the wheel 5C) on the left side of the vehicle body 2, and a right electric motor to rotate and drive driving wheel(s) which is/are at least one of the front wheel 5F or the rear 5R (or the wheel 5C) on the right side of the vehicle body 2. Alternatively, the working vehicle 1 may include four electric motors to rotate and drive the front wheel 5F on the left front side, the front wheel 5F on the right front side, the rear wheel 5R (or wheel 5C) on the left rear side, and the rear wheel 5R (or wheel 5C) on the right rear side of the vehicle body 2, respectively.

The steering system 16 is operable to change the steering direction and steering angle (angle of steering) of the working vehicle 1 (vehicle body 2). The steering system 16 includes a steering wheel 16a, a steering shaft 16b, a steering actuator 16c, and a pair of left and knuckle arms 16d, as illustrated in FIG. 4.

The steering wheel 16a is located inside the cabin 9 (FIG. 1) and is operated by a driver seated in the seat 8. The steering shaft 16b rotatably supports the steering wheel 16a. The steering actuator 16c includes, for example, an electric cylinder, which is actuated to extend or retract according to the angle and direction of rotation of the steering shaft 16b. The knuckle arms 16d are connected to the steering actuator 16c, and move as the steering actuator 16c is actuated (extends or retracts), thus changing the orientation of the front wheels 5F. The steering system 16, which is configured as described above, thus changes the orientation of the front wheels 5F to change the steering direction and steering angle (angle of steering) of the vehicle body 2, thus steering the working vehicle 1.

The steering system 16 is configured such that the steering actuator 16c is actuated not only by manual operation of the steering wheel 16a by the driver but also by a control signal from the controller 11 to change the orientation of the front wheels 5F. As another example, the steering actuator 16c may include a hydraulic actuator such as a hydraulic cylinder or an electric actuator such as a servo cylinder or a servomotor.

The braking system 17 (FIG. 3) brakes the traveling device 5. The braking system 17 includes a brake such as a pedal or lever located inside the cabin 9, a braking actuator, and a disc brake mechanism. The braking system 17 is configured such that the braking actuator is actuated in response to the manual operation of the brake or the like or a control signal from the controller 11 to actuate the brake mechanism to brake the pair of left and right rear wheels 5R (or wheels 5C).

The linkage 6 includes the foregoing actuator(s) for lifting and a lifting switch. The actuator(s) for lifting is/are actuated in response to an operation signal from the lifting switch or a control signal from the controller 11 to raise or lower the working device 4 connected to the linkage 6. The low-voltage battery 18 is operable to output lower-voltage electricity than the high-voltage battery 12 to the controller 11 and to electrical component(s) in or on the working vehicle 1.

The forward/rearward travel switching lever 10 is located inside the cabin 9. The forward/rearward travel switching lever 10 is operated by the driver (user) to input an instruction to perform a forward/rearward travel switching action to switch the direction of travel of the vehicle body 2 (working vehicle 1) between forward and rearward. That is, the forward/rearward travel switching lever 10 is an input device (input interface) to receive input of an instruction to perform the forward/rearward travel switching action. Upon receipt of an instruction to perform the forward/rearward travel switching action via the forward/rearward travel switching lever 10, the controller 11 causes the motor controller 11b and the inverter 14 to control the rotation speed and the direction of rotation of the electric motor 3 to perform the forward/rearward travel switching action (switching of the direction of travel of the vehicle body 2 from forward to rearward or from rearward to forward).

As another example, a manual operator other than a lever, such as a pushbutton, tumbler switch, and/or a pedal, may be provided in or on the working vehicle 1 as an input interface to receive input of an instruction to perform the forward/rearward travel switching action. Alternatively, a manual operator, such as a key generated by a software program on a display included in the user interface 20, may define an input interface to receive input of an instruction to perform the forward/rearward travel switching action.

The accelerator 19, the user interface 20, the internal sensor unit 21, the external sensor unit 22, the position detector 23, and the communicator 24 are input devices (input interfaces) to receive input of status information (including signals and data) indicating the state (status) of at least one of the state of the working vehicle 1 or the environment surrounding the working vehicle 1. The controller 11 causes the memory 11a to store the status information inputted via the input interface(s). The status information also includes status information indicating the state of the working device 4 connected to the working vehicle 1.

The memory 11a may store, in advance, at least one of the following types of status information: vehicle information relating to the working vehicle 1, device information relating to the working device 4 connectable to the working vehicle 1 (vehicle body 2), and map information including geographic features of the location (region) where the working vehicle 1 travels. The map information may include agricultural field information relating to an agricultural field in which the working vehicle 1 performs work using the working device 4 while traveling, and zone information relating to zone(s) other than the agricultural field. The agricultural field information may include information indicating the contour, geographic feature(s), and location of the agricultural filed, the location of a work area and the location of a headland in the agricultural field. The zone information may include map(s), geographic feature(s), and location(s) of the zone(s).

The accelerator 19 is operated by the driver (user) to change the vehicle speed of the vehicle body 2 (working vehicle 1). The accelerator 19 includes a manual operator such as a lever, a pedal and/or a switch provided in the cabin 9, and an electric circuit to output an operation signal according to the operation amount of the manual operator, for example. The target vehicle speed determiner 11e of the controller 11 detects the operation amount of the accelerator 19 based on the operation signal from the accelerator 19, and determines a target vehicle speed based on the operation amount. The controller 11 then controls the inverter 14 to control the rotation speed of the electric motor 3 to drive the traveling device 5 such that the vehicle speed of the vehicle body 2 reaches the target vehicle speed.

The user interface 20 includes a touch panel, a display, a speaker, and/or the like provided inside the cabin 9. The driver can use the user interface 20 to input the status information of the working vehicle 1, and the status information of the working device 4 connected to the working vehicle 1. The driver can use the user interface 20 to input the agricultural field information relating to an agricultural field in which the working vehicle 1 travels and the zone information relating to zone(s) other than the agricultural field, which are the status information of the surrounding environment of the working vehicle 1. The user interface 20 also outputs various information to the driver by displaying the information on the display or outputting the information in sound form via a speaker. The user interface 20 also functions as an output device (output interface) and a display to display information.

The internal sensor unit 21 includes a plurality of (a plurality of types of) sensors to receive input of status information indicating the state (status) of each element of the working vehicle 1. The internal sensor unit 21 includes a person sensor 21a, a steering angle sensor 21b, a rotation speed sensor 21c, an inertial measurement unit (IMU) 21d, and a load sensor 21e. Note that the internal sensor unit 21 may be the one that includes at least one of the person sensor 21a, the steering angle sensor 21b, the rotation speed sensor 21c, the IMU 21d, or the load sensor 21e. The internal sensor unit 21 may include sensor(s) other than the sensors listed above.

The person sensor 21a includes, for example, a seat switch provided in a seating portion of the seat 8, a camera to capture an image of the interior of the cabin 9, and/or a biosensor provided inside the cabin 9. The person sensor 21a detects whether or not a person is present in the working vehicle 1. The controller 11 may be configured or programmed to determine whether or not a person is present in the working vehicle 1 based on the detected result from the person sensor 21a.

The steering angle sensor 21b detects the steering angle of the vehicle body 2. Specifically, the steering angle sensor 21b includes an angle sensor to detect the angle of rotation of the steering shaft of the steering system 16. The controller 11 then detects, as the steering angle of the vehicle body 2, the angle of rotation of the steering shaft detected by the angle sensor. The controller 11 may be configured or programmed to determine whether the vehicle body 2 is traveling straight or turning based on the steering angle detected by the steering angle sensor 21b. For example, the controller 11 is configured or programmed to determine that the vehicle body 2 is traveling straight if the steering angle of the vehicle body 2 is less than a predetermined value, and determine that the vehicle body 2 is turning if the steering angle is equal to or greater than the predetermined value.

The rotation speed sensor 21c detects the rotation speed of the electric motor 3. The IMU 21d detects the three-dimensional inertial motion (translation along and rotation around three orthogonal axes) of the vehicle body 2. The actual vehicle speed detector 11d of the controller 11 calculates (detects) the vehicle speed (actual vehicle speed) of the vehicle body 2 based on the rotation speed of the electric motor 3 detected by the rotation speed sensor 21c, for example. Additionally or alternatively, the actual vehicle speed detector 11d calculates the acceleration of the vehicle body 2 based on the detection result from the IMU 21d, and calculates (detects) the vehicle speed of the vehicle body 2 from the acceleration.

The controller 11 detects (calculates) the direction of travel of the vehicle body 2 based on the detected result from the IMU 21d. The controller 11 detects (calculates) the posture of the vehicle body 2 such as the pitch angle, the roll angle, and/or the yaw angle (direction, orientation) of the vehicle body 2, based on the detected result from the IMU 21d. The controller 11 uses the yaw angle calculated from the detected result from the IMU 21d as the steering angle of the vehicle body 2. The IMU 21d also functions as a sensor to detect the steering angle of the vehicle body 2.

The controller 11 may be configured or programmed to use the yaw angle calculated from the detected result from the IM 21d as the steering angle of the vehicle body 2 and determine whether the vehicle body 2 is traveling straight or turning. For example, the controller 11 is configured or programmed to determine that the vehicle body 2 is traveling straight if the yaw angle of the vehicle body 2 is less than a predetermined value, and determine that the vehicle body 2 is turning if the yaw angle is equal to or greater than the predetermined value.

The controller 11 may be configured or programmed to determine whether the vehicle body 2 (working vehicle 1) is traveling on a level ground or a sloping ground based on the pitch angle of the vehicle body 2 calculated from the detected result from the IMU 21d. For example, the controller 11 is configured or programmed to determine that the vehicle body 2 is traveling on a level ground with a degree of inclination less than a predetermined value if the pitch angle of the vehicle body 2 is less than a predetermined value, and determine that the vehicle body 2 is traveling on a sloping ground with a degree of inclination equal to or greater than the predetermined value if the pitch angle of the vehicle body 2 is equal to or greater than the predetermined value.

The load sensor 21e detects the load on the linkage 6. The controller 11 determines whether or not a working device 4 is connected to the linkage 6 and determines the weight and type of the working device 4 connected to the linkage 6, based on the load detected by the load sensor 21e.

Specifically, for example, the controller 11 determines that no working devices 4 are connected if the load detected by the load sensor 21e is less than a predetermined value, and determines that a working device 4 is connected if the load is equal to or greater than the predetermined value. The controller 11 determines that a lightweight working device 4 is connected if the load detected by the load sensor 21e is equal to or greater than the predetermined value and less than a threshold which is greater than the predetermined value, and determines that a heavyweight working device 4 is connected if the load is equal to or greater than the threshold.

The external sensor unit 22 includes a plurality of (a plurality of types of) sensors to receive input of status information (including signals and data) indicating the state of the surrounding environment of the working vehicle 1. The external sensor unit 22 includes laser sensor(s) 22a such as Light Detection and Ranging, Laser Imaging Detection and Ranging (LiDAR) and camera(s) 22c. The laser sensor(s) 22a and the camera(s) 22c are located at appropriate positions on the working vehicle 1 such as a front portion, a rear portion, left and right side portions, an upper portion, a lower portion, and/or the like of the working vehicle 1 to detect the state of the surrounding environment of the working vehicle 1 and the working device 4. Note that the external sensor unit 22 may be the one that includes at least one of the laser sensor(s) 22a and the camera(s) 22c. The external sensor unit 22 may include some other sensor(s) (such as ultrasonic sensor(s)).

The laser sensor 22a detects to-be-detected objects within a predetermined distance from the working vehicle 1, and measures the distance to each to-be-detected object using time of flight (TOF). The camera 22c captures an image of a surrounding area of the working vehicle 1 such as an area forward of, an area rearward of, an area leftward of, and/or an area rightward of the working vehicle 1. The controller 11 detects to-be-detected objects in the surrounding area of the working vehicle 1 (within the area an image of which is captured by the camera 22c) based on at least one of the detected result from the laser sensor 22a or the image captured by the camera 22c. The to-be-detected objects not only include obstacles that would hinder the travel of the working vehicle 1 but also objects other than the obstacles such as the ground surface (road surface) on which the working vehicle 1 travels and the working device 4 connected to the linkage 6. The laser sensor 22a and the camera 22c also function as sensors to detect the working device 4 connected to the linkage 6.

The controller 11 may be configured or programmed to determine whether or not a working device 4 is connected to the linkage 6 based on at least one of the detected result from the laser sensor 22a or the image captured by the camera 22c. The controller 11 may be configured or programmed to determine the type of the working device 4 connected to the linkage 6 based on the image captured by the camera 22c that is positioned to capture images of the area rearward of the working vehicle 1.

Specifically, the controller 11 extracts the image of the working device 4 from the image of the area rearward of the vehicle body 2 captured by the camera 22c, and determines the type of the working device 4, i.e., the name of the type (e.g., tiller, spreader, [ . . . ], or harvester) indicating the purpose of use of the working device 4 (work that the working device 4 can perform), based on the image of the working device 4. Additionally or alternatively, the controller 11 determines the type of the working device 4 which is either a directly attached working device supported by the vehicle body 2 or a towed working device towed by the vehicle body 2.

Additionally or alternatively, the controller 11 may be configured or programmed to determine the type of the working device 4 which is either a small working device having a height and a width less than predetermined values or a large working device having a height and a width at least one of which is equal to or greater than the corresponding predetermined value. The controller 11 may be configured or programmed to, if determining that the working device 4 connected to the linkage 6 is a small working device, determine (estimate) that the working device 4 is a lightweight working device and, if determining that the working device 4 connected to the linkage 6 is a large working device, determine (estimate) that the working device 4 is a heavyweight working device.

The controller 11 may be configured or programmed to determine at least one of geographic feature(s) or the size of a location where the working vehicle 1 is located based on at least one of the detected result from the laser sensor 22a or the image captured by the camera 22c. For example, the controller 11 is configured or programmed to determine the inclination of the ground surface on which the vehicle body 2 is located, based on at least one of the detected result from the laser sensor 22a or the image captured by the camera 22c. The laser sensor 22a and the camera 22c also function as sensors to detect the inclination of the ground surface.

More specifically, the controller 11 determines whether or not the ground surface on which the vehicle body 2 is located is sloping based on at least one of the detected result from the laser sensor 22a or the image captured by the camera 22c. The controller 11 then, if determining that the ground surface is sloping, determines that the working vehicle 1 is traveling on a sloping ground, and, if determining that the ground surface on which the vehicle body 2 is located is not sloping, determines that the working vehicle 1 is traveling on a level ground.

The controller 11 may be configured or programmed to calculate the degree of inclination of the ground surface on which the vehicle body 2 is located, based on at least one of the detected result from the laser sensor 22a or the image captured by the camera 22c. The controller 11 may be configured or programmed to, if determined that the degree of inclination is less than a predetermined value, determine that the working vehicle 1 is traveling on a level ground, and, if determining that the degree of inclination is equal to or greater than the predetermined value, determine that the working vehicle 1 is traveling on a sloping ground.

The controller 11 may be configured or programmed to determine the direction of slope of the ground surface (sloping upward or sloping downward) based on at least one of the detected result from the laser sensor 22a or the image captured by the camera 22c. The controller 11 may be configured or programmed to determine whether the vehicle body 2 (working vehicle 1) is traveling up the sloping ground (climbing a slope) or traveling down the sloping ground (traveling down a slope) based on the direction of slope of the ground surface. Specifically, the controller 11 determines that the vehicle body 2 is traveling up a slope if the ground surface is sloping upward in the direction of travel of the vehicle body 2, and determines that the vehicle body 2 is traveling down a slope if the ground surface is sloping downward in the direction of travel of the vehicle body 2.

The controller 11 may be configured or programmed to, based on at least one of the detected result from the laser sensor 22a or the image captured by the camera 22c, detect the position of obstacle(s), and determine the size of an area that allows the working vehicle 1 to travel without contacting the obstacle(s) (e.g., determine the area of a travelable range).

The position detector 23 is provided in or on the vehicle body 2 to detect the position thereof (measured position information including latitude and longitude) using a global navigation satellite system (GNSS). Specifically, the position detector 23 includes a GNSS receiver to receive signals (positions of positioning satellites, time of transmission, correction information, etc.) transmitted from positioning satellite(s), and detects the position thereof based on the signal(s) received via the GNSS receiver. The controller 11 may be configured or programmed to use the position detected by the position detector 23 as the position of the vehicle body 2 (working vehicle 1) and determine whether the vehicle body 2 is traveling straight or turning based on time-series data about the position. The actual vehicle speed detector 11d may be configured or programmed to detect (calculate) the vehicle speed of the vehicle body 2 based on time-series data about the position detected by the position detector 23.

The communicator 24 functions as a communication interface to communicate with at least one of the working device 4, a server 31, a terminal device 32, or a remote device 33 and functions as an input/output interface. The communicator 24 includes a wired communication port 24a, a short-range communicator 24b, and a wide-area communicator 24c. Note that the communicator 24 may be the one that includes at least one of the wired communication port 24a, the short-range communicator 24b, or the wide-area communicator 24c.

The wired communication port 24a allows wired communication with an electronic controller such as a CPU included in the working device 4 or some other electronic device. Upon connection of the electronic controller of the working device 4 to the wired communication port 24a via an electric cable, the controller 11 can communicate with the electronic controller. Upon connection of some other electronic device (e.g., a computer or a storage medium) to the wired communication port 24a via an electric cable, the controller 11 can communicate with the electronic device.

The short-range communicator 24b is a wireless communicator to transmit and receive wireless signals compliant with a near field communication standard such as Bluetooth (registered trademark) Low Energy. In the case where the working device 4 connected to the linkage 6 includes a wireless communicator compliant with a near field communication standard and an electronic controller, the electronic controller and the controller 11 communicate with each other in a wireless manner via the wireless communicator and the short-range communicator 24b to transmit and receive information.

The information transmitted from the electronic controller of the working device 4 or the like (including other electronic device(s)) to the controller 11 via the wired communication port 24a in a wired manner or via the short-range communicator 24b in a wireless manner includes identification information of the working device 4. The memory 11a of the controller 11 stores pieces of identification information of working devices 4 connectable to the linkage 6 and usable with the working vehicle 1, and pieces of device information each indicating at least one of the type or specifications of the corresponding working device 4, which are associated with each other. The controller 11 reads, from the memory 11a, the piece of device information that corresponds to the piece of identification information of a working device 4 received from the electronic controller of the working device 4 or the like, and determines the type, etc., of the working device 4 connected to the linkage 6 based on the read piece of device information.

Additionally or alternatively, the information transmitted from the electronic controller of the working device 4 or the like to the controller 11 in a wired or wireless manner may include device information indicating the type, etc., (and specifications) of the working device 4. In such a case, the controller 11 determines the type, etc., of the working device 4 connected to the linkage 6 based on the device information received from the electronic controller of the working device 4 or the like.

The wide-area communicator 24c communicates with at least one of the server 31, the terminal device 32, or the remote device 33 via a wide-area network such as a mobile telephone communication network and/or the Internet. The server 31 is a computer located at a control center or a cloud system. The server 31 includes a database built therein, and the database stores vehicle information about the working vehicle 1, device information about working device(s) 4 connectable to the working vehicle 1, map information including geographic features of locations such as an agricultural field in which the working vehicle 1 is located and travels and zone(s) other than the agricultural field, and/or the like.

The terminal device 32 is a portable or stationary computer. The terminal device 32 includes a user interface, and the user interface can be used to input and output vehicle information of the working vehicle 1, device information of the working device 4, and map information about a location in which the working vehicle 1 is located and travels. The remote device 33 is operated by a user at a remote location to remotely control the working vehicle 1.

The controller 11 communicates, via the wide-area communicator 24c, at least one of the server 31 or the terminal device 32 to receive vehicle information of the working vehicle 1, device information of the working device 4, and map information about a location in which the working vehicle 1 is located and travels. The controller 11 communicates with the remote device 33 via the wide-area communicator 24c to receive a remote control signal transmitted from the remote device 33 in response to the user operation.

At least one of the vehicle information received by the wide-area communicator 24c of the communicator 24, the vehicle information inputted via the user interface 20, or the vehicle information stored in advance in the memory 11a indicates whether the working vehicle 1 is a manned working vehicle or an unmanned working vehicle. Thus, the controller 11 may be configured or programmed to determine whether or not a person is present in the working vehicle 1 based on the vehicle information. Specifically, the controller 11 is configured or programmed to, if at least one of the above types of vehicle information indicates that the working vehicle 1 is a manned working vehicle, determine that a person is present in the working vehicle 1, and if at least one of the above types of vehicle information indicates that the working vehicle 1 is an unmanned working vehicle, determine that no persons are present in the working vehicle 1.

The controller 11 may be configured or programmed to, upon receipt of device information of a working device 4 via the wired communication port 24a or the short-range communicator 24b of the communicator 24, determine that the working device 4 is connected to the vehicle body 2, and if no device information is received, determine that no working devices 4 are connected to the vehicle body 2. The controller 11 may be configured or programmed to, upon receipt of input of device information of a working device 4 connected to the vehicle body 2 via the user interface 20, determine that the working device 4 is connected to the vehicle body 2.

The controller 11 may be configured or programmed to determine the type of the working device 4 connected to the vehicle body 2 based on device information received via the wired communication port 24a or the short-range communicator 24b, device information inputted via the user interface 20, and/or device information stored in advance in the memory 11a.

The controller 11 may be configured or programmed to, based on map information received via the wide-area communicator 24c of the communicator 24 and based on the position (of the vehicle body 2) detected by the position detector 23, read from the map information the degree of inclination of the ground surface on which the position is located, and determine whether the vehicle body 2 is traveling on a level ground or a sloping ground based on the degree of inclination. Specifically, the controller 11 is configured or programmed to, when the electric motor 3 is being driven, compare the map information with the position detected by the position detector 23, and detect the degree of inclination of the ground surface on which the position is located. The controller 11 is configured or programmed to then, based on the result of comparison, determine that the vehicle body 2 is traveling on a level ground if the degree of inclination of the ground surface on which the position detected by the position detector 23 is located is less than a predetermined value, and determine that the vehicle body 2 is traveling on a sloping ground if the degree of inclination is equal to or greater than the predetermined value. The controller 11 may be configured or programmed to determine whether the vehicle body 2 is traveling up a sloping ground or traveling down a sloping ground based on the degree of inclination of the ground surface on which the position detected by the position detector 23 is located and based on the direction of travel of the vehicle body 2.

The working vehicle 1 is operable to be manually controlled by the driver (person) sitting on the seat 8 (FIG. 1) operating the steering wheel 16a, the accelerator 19, the brake and/or the like to perform actions such as traveling and working (i.e., such an operation is manual operation). The working vehicle 1 is operable to be also automatically controlled by the automatic operation controller 11c of the controller 11 controlling the inverter 14, the electric motor 3, the steering system 16, the braking system 17, the linkage 6 and/or the like to perform actions such as traveling and working without relying on the manual control (i.e., such an operation is automatic operation).

The automatic operation of the working vehicle 1 includes at least one of automatic travel, autonomous travel, or remote operation. The automatic travel of the working vehicle 1 is a mode in which the automatic operation controller 11c controls the inverter 14, the electric motor 3, the steering system 16, the braking system 17, and/or the like based on a preset travel route and the position (of the vehicle body 2) detected by the position detector 23 to cause the working vehicle 1 to automatically travel along the travel route.

For example, in the case where the automatic travel of the working vehicle 1 is performed in an agricultural field, the automatic operation controller 11c, based on a travel route and the position detected by the position detector 23, causes the working vehicle 1 to automatically travel along the travel route while causing the working device 4 connected to the linkage 6 to perform work in a work area in the agricultural field. Information indicating the travel route may be stored in advance in the memory 11a or may be transmitted from the server 31, the terminal device 32 or the like and received via the wide-area communicator 24c.

The autonomous travel of the working vehicle 1 is a mode in which the automatic operation controller 11c, while determining a travel route to a pre-set goal point, controls the inverter 14, the electric motor 3, the steering system 16, the braking system 17, and/or the like based on the travel route and the position detected by the position detector 23 to cause the working vehicle 1 to automatically travel along the travel route. Information indicating the goal point may be inputted by the driver via the user interface 20 or may be inputted by the user via the terminal device 32 and then transmitted from the terminal device 32 to the wide-area communicator 24c.

The remote operation of the working vehicle 1 is a mode in which the automatic operation controller 11c controls the inverter 14, the electric motor 3, the steering system 16, the braking system 17, and/or the like based on a remote control signal transmitted from the remote device 33 and received via the wide-area communicator 24c to cause the working vehicle 1 to automatically travel and the working device 4 to perform work. The remote device 33 includes one or more manual operators corresponding to the steering wheel 16a, the forward/rearward travel switching lever 10, the manual operator of the accelerator 19, the brake, the lifting switch, and/or the like of the working vehicle 1, and a remote control signal corresponding to the operation of the manual operator(s) is transmitted from the remote device 33 to the working vehicle 1.

The remote control signal transmitted from the remote device 33 includes an instruction to perform the forward/rearward travel switching action (hereinafter may be referred to as “instruction to perform action”) which is transmitted upon operation of a manual operator corresponding to the forward/rearward travel switching lever 10. The instruction to perform action is received by the wide-area communicator 24c of the communicator 24. The communicator 24 is an input device (input interface) to receive input of an instruction to perform the forward/rearward travel switching action transmitted from the remote device 33.

As another example, the working vehicle 1 may be configured to operate in automatic operation without operating in manual operation. In such a case, the seat 8 and the protection structure such as the cabin 9 to protect the driver sitting in the seat 8 of the working vehicle 1 are not essential. As another example, the working vehicle 1 may be configured to operate in manual operation without operating in automatic operation.

The characteristics determiner 11f of the controller 11 determines (defines) forward/rearward travel switching characteristics which are characteristics relating to the rapidity of the forward/rearward travel switching action of the working vehicle 1 from the start to the end of the forward/rearward travel switching action (vehicle body 2). Specifically, the forward/rearward travel switching characteristics determined by the characteristics determiner 11f include at least one of (i) the duration of the forward/rearward travel switching action or (ii) a vehicle-speed change rate which is a change in vehicle speed per unit time during the forward/rearward travel switching action. The controller 11 is configured or programmed to, based on the forward/rearward travel switching characteristics determined by the characteristics determiner 11f, cause the motor controller 11b to actuate the inverter 14 to control the rotation speed and the rotation (driving) direction of the electric motor 3 to perform the forward/rearward travel switching action of the working vehicle 1 via the traveling device 5.

The controller 11 is configured or programmed to, upon a user such as the driver operating the forward/rearward travel switching lever 10 to input an instruction to perform the forward/rearward travel switching action, cause the characteristics determiner 11f to determine the forward/rearward travel switching characteristics and cause the motor controller 11b to perform the forward/rearward travel switching action based on the forward/rearward travel switching characteristics. Additionally or alternatively, the controller 11 is configured or programmed to, upon receipt of (input of), via the communicator 24, the instruction to perform the forward/rearward travel switching action transmitted from the remote device 33, cause the characteristics determiner 11f to determine the forward/rearward travel switching characteristics and cause the motor controller 11b to perform the forward/rearward travel switching action based on the forward/rearward travel switching characteristics.

Additionally or alternatively, the controller 11 is configured or programmed to determine the point in time at which the forward/rearward travel switching action of the working vehicle 1 is to be performed, based on the state of the working vehicle 1 and/or the surrounding environment of the working vehicle 1 indicated by status information inputted via at least one of the user interface 20, the internal sensor unit 21, the external sensor unit 22, position detector 23, the communicator 24, or the like. The controller 11 is configured or programmed to, at the determined point in time, cause the characteristics determiner 11f to determine the forward/rearward travel switching characteristics, and cause the motor controller 11b to perform the forward/rearward travel switching action based on the determined forward/rearward travel switching characteristics.

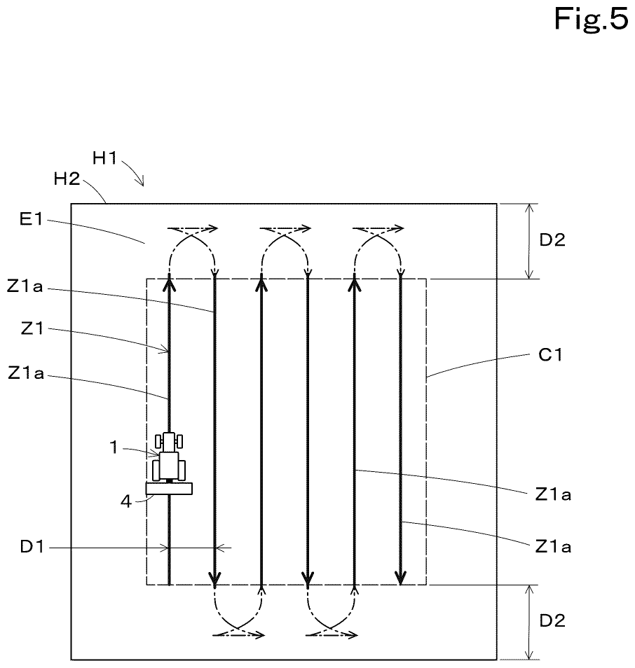

Specifically, the controller 11 is configured or programmed to, while the vehicle body 2 is automatically traveling based on a travel route Z1 defined in an agricultural field H1 as illustrated in, for example, FIG. 5 (during automatic travel or during autonomous travel), determines the point in time at which the forward/rearward travel switching action is to be performed based on agricultural field information relating to the agricultural field H1 indicated by the status information, based on the position (of the vehicle body 2) detected by the position detector 23, and based on the travel route Z1.

More specifically, the working vehicle 1 may need to make a multi-point turn as represented by dot-dash line in a headland E1 which is between the work area C1 and an edge H2 of the agricultural field H1 to change the direction of travel, and therefore, for example, the controller 11 may be configured or programmed to, if the distance D1 between straight portions Zia of the travel route Z1 defined in a work area C1 at the center of the agricultural field H1 is less than a first predetermined value, determine the point in time at which the forward/rearward travel switching action is to be performed when the position of the vehicle body 2 reaches the end point (the point of solid bold arrow) of one of the straight portions Z1a. The controller 11 may be configured or programmed to, even if the distance D1 between the straight portions Z1a is equal to or greater than the first predetermined value, in the case where a headland width D2 which is the distance from the work area C1 to the edge H2 of the agricultural field H1 is less than a second predetermined value, determine the point in time at which the forward/rearward travel switching action is to be performed when the position of the vehicle body 2 reaches the end point of one of the straight portions Z1a.

As another example, the controller 11 may be configured or programmed to determine the point in time at which the forward/rearward travel switching action is to be performed when, while the working vehicle 1 is traveling, the distance to an obstacle detected by at least one of the laser sensor 22a or the camera 22c decreases below a third predetermined value. The controller 11 may be configured or programmed to, when the instruction to perform the forward/rearward travel switching action is inputted from a controller of the working vehicle 1 or an external device such as the server 31 or the terminal device 32 other than the forward/rearward travel switching lever 10 and the remote device 33, cause the characteristics determiner 11f to determine the forward/rearward travel switching characteristics, and perform the forward/rearward travel switching action based on the forward/rearward travel switching characteristics.

The controller 11 may determine the forward/rearward travel switching characteristics while the working vehicle 1 is traveling or may determine the forward/rearward travel switching characteristics while the working vehicle 1 is in the stopped state (when the vehicle speed is zero). The controller 11 may determine the forward/rearward travel switching characteristics at, before or after the point in time at which the working vehicle 1 starts performing the forward/rearward travel switching action. That is, the controller 11 may be configured or programmed to cause the characteristics determiner 11f to determine the forward/rearward travel switching characteristics when the working vehicle 1 is not performing the forward/rearward travel switching action, or may be configured or programmed to cause the characteristics determiner 11f to determines the forward/rearward travel switching characteristics during the forward/rearward travel switching action.

The controller 11 may be configured or programmed to cause the motor controller 11b to perform the forward/rearward travel switching action based on the forward/rearward travel switching characteristics while the working vehicle 1 (vehicle body 2) is traveling, or may be configured or programmed to cause the motor controller 11b to perform the forward/rearward travel switching action based on the forward/rearward travel switching characteristics when the working vehicle 1 is in the stopped state.

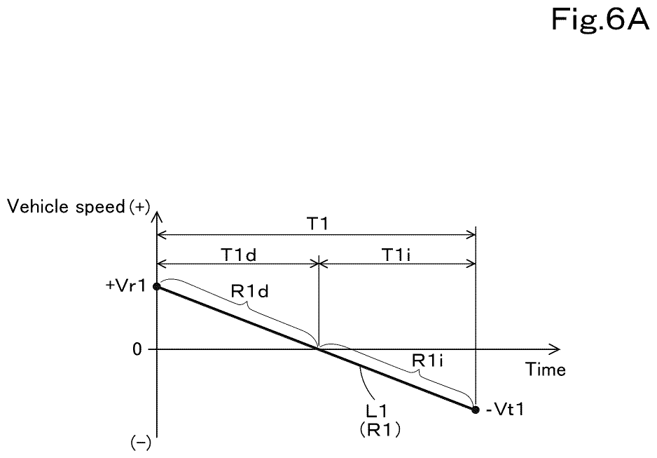

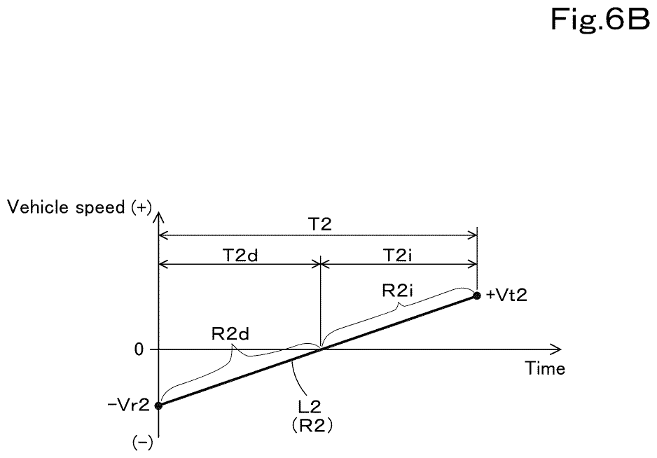

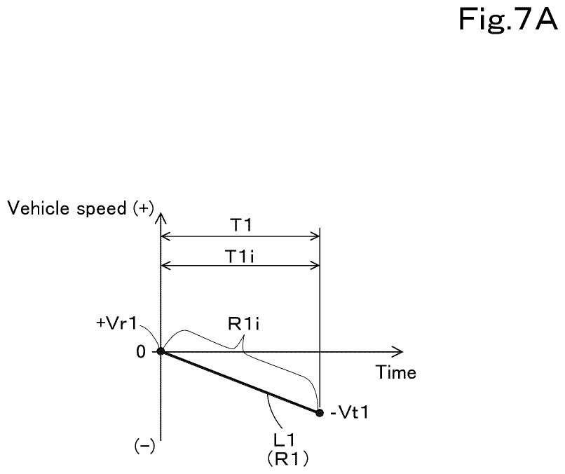

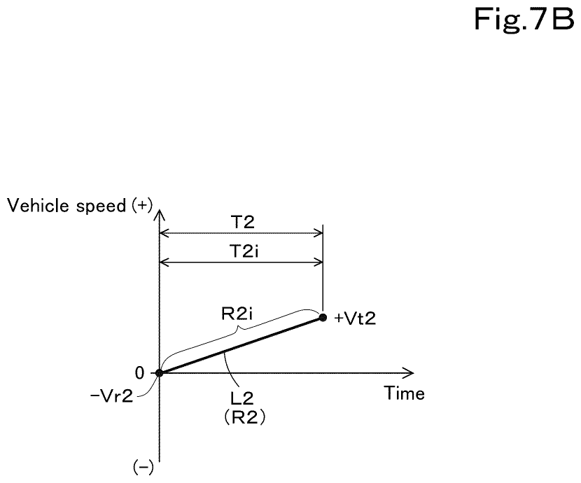

FIGS. 6A and 6B show graphs showing examples of the forward/rearward travel switching characteristics. Specifically, FIG. 6A is a graph showing an example of forward/rearward travel switching characteristics for switching from forward travel of the vehicle body 2 to rearward travel (the same applies to FIGS. 7A, 9A, 9B, and 10A, described later). FIG. 6B is a graph showing an example of the forward/rearward travel switching characteristics for switching from rearward travel of the vehicle body 2 to forward travel (the same applies to FIGS. 7B, 9C, 9D, 10B, described later). The horizontal axis in the charts in FIGS. 6A and 6B represents time, and the vertical axis in the charts in FIGS. 6A and 6B represents the vehicle speed of the vehicle body 2 (working vehicle 1). When the vehicle body 2 travels forward, the vehicle speed has a positive (+, plus) value more than zero (0), and when the vehicle body 2 travels rearward, the vehicle speed has a negative (−, minus) value less than zero (0) (the same applies to the graphs showing examples of the forward/rearward travel switching characteristics in FIGS. 7A to 11, described later).

The controller 11 is configured or programmed to, first, before (immediately before) the forward/rearward travel switching action is started, cause the actual vehicle speed detector 11d to detect the current vehicle speed +Vr1 or −Vr2 which is an initial vehicle speed and cause the target vehicle speed determiner 11e to determine a target vehicle speed −Vt1 or +Vt2. Note that the controller 11 is configured or programmed to cause the target vehicle speed determiner 11e to determine the target vehicle speed −Vt1 or +Vt2 based on the operation amount of the accelerator 19. Note, however, that as another example, the target vehicle speed −Vt1, +Vt2 may be a preset fixed value or a value obtained by inverting the sign (+), (−) of the initial vehicle speed +Vr1, −Vr2 (i.e., the target vehicle speed −Vt1 may be −Vr1, the target vehicle speed +Vt2 may be +Vr2).

The controller 11 is configured or programmed to cause the characteristics determiner 11f to determine forward/rearward travel switching characteristics, i.e., determine a duration T1 or T2 over which the vehicle speed changes from the initial vehicle speed +Vr1 or −Vr2 to reach the target vehicle speed −Vt1 or +Vt2, for example. The controller 11 is configured or programmed to, when the direction of travel of the vehicle body 2 is switched from forward to rearward, cause the characteristics determiner 11f to determine a first duration T1 over which the vehicle speed changes from the initial vehicle speed (actual vehicle speed of forward travel)+Vr1 to reach the rearward-travel target vehicle speed −Vt1 (see FIG. 6A). The controller 11 is configured or programmed to, in the case where the direction of travel is switched from rearward to forward, cause the characteristics determiner 11f to determine a second duration T2 over which the vehicle speed changes from the initial vehicle speed (actual vehicle speed of rearward travel) −Vr2 to reach the forward-travel target vehicle speed +Vt2 (see FIG. 6B).

The forward/rearward travel switching characteristics determined by the controller 11 (by the characteristics determiner 11f of the controller 11) to change the direction of travel of the vehicle body 2 from forward to rearward may include (i) a first speed reduction time period T1d over which the vehicle body 2 traveling forward reduces the vehicle speed thereof from the initial vehicle speed +Vr1 to 0 (zero) and (ii) a first speed increase time period T1i over which the vehicle body 2 increases the vehicle speed from 0 to the rearward-travel target vehicle speed −Vt1 at which the vehicle body 2 travels rearward (see FIG. 6A). The first duration T1 is the sum of the first speed reduction time period T1d and the first speed increase time period T1i.

The forward/rearward travel switching characteristics determined by the controller 11 (by the characteristics determiner 11f of the controller 11) to change the direction of travel of the vehicle body 2 from rearward to forward may include (i) a second speed reduction time period T2d over which the vehicle body 2 traveling rearward reduces the vehicle speed thereof to 0 (zero) and (ii) a second speed increase time period T2i over which the vehicle body 2 increases the vehicle speed thereof from 0 to the forward-travel target vehicle speed +Vt2 at which the vehicle body 2 travels forward (see FIG. 6B). The second duration T2 is the sum of the second speed reduction time period T2d and the second speed increase time period T2i.

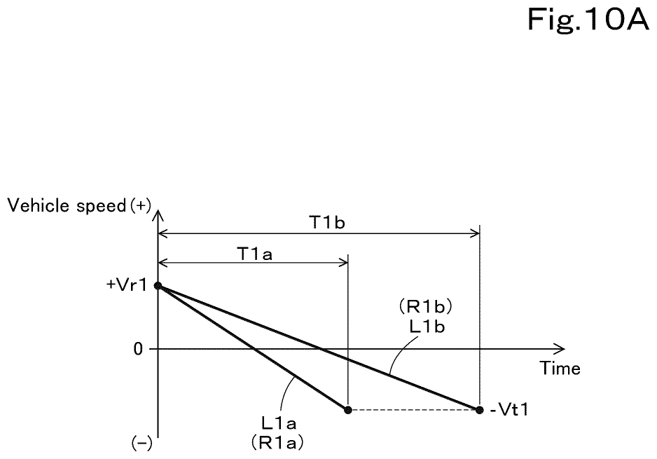

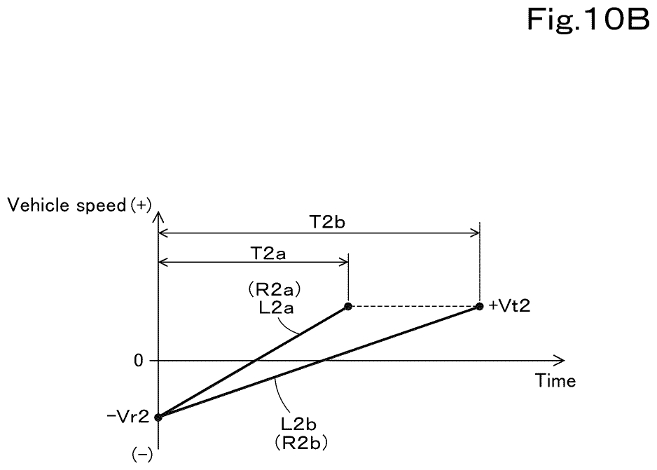

The controller 11 may be configured or programmed to, using the determined first duration T1 and the determined second duration T2 as base durations, cause the characteristics determiner 11f of the controller 11 to multiply each of the first and second durations T1 and T2 by a corresponding coefficient to modify at least one of the first duration T1 or the second duration T2 to obtain a definitive first duration T1 and a definitive second duration T2 (see FIGS. 10A and 10B, described later). The controller 11 may be configured to cause the characteristics determiner 11f of the controller 11 to multiply the first speed reduction time period T1d, the first speed increase time period T1i, the second speed reduction time period T2d, and the second speed increase time period T2i each by a corresponding coefficient to modify at least one of the time periods T1d, T1i, T2d, and T2i to obtain definitive time periods T1d, T1i, T2d, and T2i. The controller 11 may be configured or programmed to determine the coefficient based on the status information.

The forward/rearward travel switching characteristics determined (calculated) by the controller 11 (by the characteristics determiner 11f of the controller 11) based on, for example, the duration(s) T1 and/or T2, etc., may include a vehicle-speed change rate R1, R2 which is a change in vehicle speed per unit time. It is noted here that, when the direction of travel of the vehicle body 2 is changed from forward to rearward, the controller 11 causes the characteristics determiner 11f to determine the first vehicle-speed change rate R1 which is a change in vehicle speed per unit time from when the vehicle speed is the initial vehicle speed +Vr1 to when the vehicle speed reaches the rearward-travel target vehicle speed −Vt1, based on the first duration T1, etc., (first speed reduction time period T1d, first speed increase time period T1i) (see FIG. 6A). The first vehicle-speed change rate R1 is the slope of a characteristics line L1 which is a straight line having a linear function and which represents a change in vehicle speed, as illustrated in FIG. 6A.

When the direction of travel of the vehicle body 2 is changed from rearward to forward, the controller 11 causes the characteristics determiner 11f to determine the second vehicle-speed change rate R2 which is a change in vehicle speed per unit time from when the vehicle speed is the initial vehicle speed −Vr2 to when the vehicle speed reaches the forward-travel target vehicle speed +Vt2, based on the second duration T2, etc., (second speed reduction time period T2d, second speed increase time period T2i) (see FIG. 6B). The second vehicle-speed change rate R2 is the slope of a characteristics line L2 which is a straight line having a linear function and which represents a change in vehicle speed, as illustrated in FIG. 6B.

The forward/rearward travel switching characteristics determined by the controller 11 (by the characteristics determiner 11f of the controller 11) to change the direction of travel of the vehicle body 2 from forward to rearward may include (i) a first speed reduction rate Rid which is a reduction in vehicle speed per unit time and at which the vehicle body 2 traveling forward reduces the vehicle speed thereof from the initial vehicle speed +Vr1 to 0 and (ii) a first speed increase rate R1 which is an increase in vehicle speed per unit time and at which the vehicle body 2 increases the vehicle speed thereof from 0 to the rearward-travel target vehicle speed −Vt1 at which the vehicle body 2 travels rearward. Note that, in the example shown in FIG. 6A, because the characteristic line L1 is a linear function, the first speed reduction rate R1d, the first speed increase rate R1, and the first vehicle-speed change rate R1 are qual to each other.

The forward/rearward travel switching characteristics determined (calculated) by the controller 11 (by the characteristics determiner 11f of the controller 11) to change the direction of travel of the vehicle body 2 from rearward to forward may include (i) a second speed reduction rate R2d which is a reduction in vehicle speed per unit time and at which the vehicle body 2 traveling rearward reduces the vehicle speed thereof from the initial vehicle speed −Vr2 to 0 and (ii) a second speed increase rate R2i which is an increase in vehicle speed per unit time and at which the vehicle body 2 increases the vehicle speed thereof from 0 to the forward-travel target vehicle speed +Vt2 at which the vehicle body 2 travels forward. Note that, in the example shown in FIG. 6B, because the characteristics line L2 is a linear function, the second speed reduction rate R2d, the second speed increase rate R2i, and the second vehicle-speed change rate R2 are equal to each other.

In the above-described examples, the controller 11 determines the duration T1, T2 and then calculates the vehicle-speed change rate R1, R2 and/or the like, which are forward/rearward travel switching characteristics. Additionally or alternatively, the controller 11 may be configured or programmed to determine the vehicle-speed change rate R1, R2 and may be configured or programmed to calculate the duration T1, T2 from the vehicle-speed change rate R1, R2.

In such a case, the controller 11 causes the characteristics determiner 11f to determine the vehicle-speed change rate R1, R2 during the period from when the vehicle speed changes form the initial vehicle speed +Vr1, −Vr2 to the target vehicle speed −Vt1, +Vt2, which is included in forward/rearward travel switching characteristics, for example. It is noted here that, when the direction of travel of the vehicle body 2 is switched from forward to rearward, the controller 11 causes the characteristics determiner 11f to determine the first vehicle-speed change rate R1 during the period from when the vehicle speed changes from the initial vehicle speed +Vr1 to the target vehicle speed −Vt1 (see FIG. 6A). In the case where the direction of travel of the vehicle body 2 is switched from rearward to forward, the controller 11 causes the characteristics determiner 11f to determine the second vehicle-speed change rate R2 during the period from when the vehicle speed changes from the initial vehicle speed −Vr2 to the target vehicle speed +Vt2 (see FIG. 6B).

The forward/rearward travel switching characteristics determined by the controller 11 (by the characteristics determiner 11f of the controller 11) to switch the direction of travel of the vehicle body 2 from forward to rearward may include the first speed reduction rate Rid and the first speed increase rate R1, as shown in FIG. 6A. The forward/rearward travel switching characteristics determined by the controller 11 (by the characteristics determiner 11f of the controller 11) to switch the direction of travel of the vehicle body 2 from rearward to forward may include the second speed reduction rate R2d and the second speed increase rate R2i.

The controller 11 may be configured or programmed to cause the characteristics determiner 11f to determine (calculate), based on the vehicle-speed change rate R1, R2, the duration T1, T2 which is included in forward/rearward travel switching characteristics. It is noted here that, when the direction of travel of the vehicle body 2 is switched from forward to rearward, the controller 11 causes the characteristics determiner 11f to determine (calculate) the first duration T1 and/or the like (first speed reduction time period T1d, first speed increase time period T1i) based on the first vehicle-speed change rate R1 and/or the like (first speed reduction rate R1d, first speed increase rate R1i) (see FIG. 6A).

When the direction of travel of the vehicle body 2 is switched from rearward to forward, the controller 11 causes the characteristics determiner 11f to determine (calculate) the second duration T2 and/or the like (second speed reduction time period T2d, second speed increase time period T2i) based on the second vehicle-speed change rate R2 and/or the like (second speed reduction rate R2d, second speed increase rate R2i) (see FIG. 6B).

The controller 11 may be configured or programmed to cause the characteristics determiner 11f to multiply the determined first vehicle-speed change rate R1 and the determined second vehicle-speed change rate R2 each by a corresponding coefficient to modify at least one of the vehicle-speed change rates R1, R2 to obtain definitive vehicle-speed change rates R1, R2 (see FIGS. 10A and 10B, described later). The controller 11 may be configured or programmed to cause the characteristics determiner 11f to multiply the determined speed reduction rates R1d, R2d and the determined speed increase rates R1i, R2i each by a corresponding coefficient to modify at least one of the speed reduction rates R1d, R2d and the speed increase rates R1i, R2i to obtain definitive speed reduction rates R1d, R2d and definitive speed increase rates R1i, R2i.

Upon determining the forward/rearward travel switching characteristics as described above, the controller 11 performs the forward/rearward travel switching action over the duration T1, T2, for example. Specifically, the controller 11 causes the inverter 14 to control the rotation speed and the rotation direction of the electric motor 3 to cause the traveling device 5 to perform the forward/rearward travel switching action over the duration T1, T2.

Specifically, in the case where the direction of travel of the vehicle body 2 is switched from forward to rearward, the controller 11 causes, over the first duration T1, the inverter 14 to change the rotation speed of the electric motor 3 from the rotation speed corresponding to the initial vehicle speed +Vr1 to the rotation speed corresponding to the rearward-travel target vehicle speed −Vt1 and reverse the rotation direction of the electric motor 3, thus changing the rotation speed of the wheels 5F, 5R(5C) of the traveling device 5 and reversing the rotation direction of the wheels 5F, 5R(5C) to cause the vehicle body 2 to travel rearward at the rearward-travel target vehicle speed −Vt1.

The controller 11 may cause, over the first speed reduction time period T1d, the inverter 14 to reduce the rotation speed of the electric motor 3 from the rotation speed corresponding to the initial vehicle speed +Vr1 to the rotation speed (which is, for example, 0 (zero)) corresponding to the vehicle speed of 0 (zero). The controller 11 may then cause, over the first speed increase time period T1i, the inverter 14 to increase the rotation speed of the electric motor 3 from the rotation speed corresponding to the vehicle speed of 0 (zero) to the rotation speed corresponding to the rearward-travel target vehicle speed −Vt1. This also causes, over the first duration T1, the rotation direction of the electric motor 3 to be reversed, the rotation speed of the wheels 5F, 5R(5C) of the traveling device 5 to be changed and the rotation direction of the wheels 5F, 5R(5C) of the traveling device 5 to be reversed, thus causing the vehicle body 2 to travel rearward at the rearward-travel target vehicle speed −Vt1.

The controller 11 may cause the inverter 14 to change the rotation speed of the electric motor 3 from the rotation speed corresponding to the initial vehicle speed +Vr1 to the rotation speed corresponding to the rearward-travel target vehicle speed −Vt1 at the first vehicle-speed change rate R1. The controller 11 may cause the inverter 14 to reduce the rotation speed of the electric motor 3 from the rotation speed corresponding to the initial vehicle speed +Vr1 to the rotation speed corresponding to the vehicle speed of 0 (zero) at the first speed reduction rate Rid and then increase the rotation speed of the electric motor 3 from the rotation speed corresponding to the vehicle speed of 0 (zero) to the rotation speed corresponding to the rearward-travel target vehicle speed −Vt1 at the first speed increase rate R1. This also causes, over the first duration T1, the rotation direction of the electric motor 3 to be reversed, the rotation speed of the wheels 5F, 5R(5C) of the traveling device 5 to be changed and the rotation direction of the wheels 5F, 5R(5C) of the traveling device 5 to be reversed, thus causing the vehicle body 2 to travel rearward at the rearward-travel target vehicle speed −Vt1.

In the case where the direction of travel of the vehicle body 2 is switched from rearward to forward, the controller 11 causes, over the second duration T2, the inverter 14 to change the rotation speed of the electric motor 3 from the rotation speed corresponding to the initial vehicle speed −Vr2 to the rotation speed corresponding to the forward-travel target vehicle speed +Vt2 and reverse the rotation direction of the electric motor 3, thus changing the rotation speed of the wheels 5F, 5R(5C) of the traveling device 5 and reversing the rotation direction of the wheels 5F, 5R(5C) to cause the vehicle body 2 to travel forward at the forward-travel target vehicle speed +Vt2.

The controller 11 may cause, over the second speed reduction time period T2d, the inverter 14 to reduce the rotation speed of the electric motor 3 from the rotation speed corresponding to the initial vehicle speed −Vr2 to the rotation speed corresponding to the vehicle speed of 0 (zero). The controller 11 may then cause, over the second speed increase time period T2i, the inverter 14 to increase the rotation speed of the electric motor 3 from the rotation speed corresponding to the vehicle speed of 0 (zero) to the rotation speed corresponding to the forward-travel target vehicle speed +Vt2. This also causes, over the second duration T2, the rotation direction of the electric motor 3 to be reversed, the rotation speed of the wheels 5F, 5R(5C) of the traveling device 5 to be changed and the rotation direction of the wheels 5F, 5R(5C) of the traveling device 5 to be reversed, thus causing the vehicle body 2 to travel forward at the forward-travel target vehicle speed +Vt2.

The controller 11 may cause the inverter 14 to change the rotation speed of the electric motor 3 from the rotation speed corresponding to the initial vehicle speed −Vr2 to the rotation speed corresponding to the forward-travel target vehicle speed +Vt2 at the second vehicle-speed change rate R2. The controller 11 may cause the inverter 14 to reduce the rotation speed of the electric motor 3 from the rotation speed corresponding to the initial vehicle speed +Vr2 to the rotation speed corresponding to the vehicle speed of 0 (zero) at the second speed reduction rate R2d and then increase the rotation speed of the electric motor 3 from the rotation speed corresponding to the vehicle speed of 0 (zero) to the rotation speed corresponding to the forward-travel target vehicle speed +Vt2 at the second speed increase rate R2i. This also causes, over the second duration T2, the rotation direction of the electric motor 3 to be reversed, the rotation speed of the wheels 5F, 5R(5C) of the traveling device 5 to be changed and the rotation direction of the wheels 5F, 5R(5C) of the traveling device 5 to be reversed, thus causing the vehicle body 2 to travel forward at the forward-travel target vehicle speed +Vt1.

Note that, in the case where, during the forward/rearward travel switching action, the accelerator 19 is operated by the user and the operation amount of the accelerator 19 is changed, the controller 11 first completes the forward/rearward travel switching action based on the forward/rearward travel switching characteristics determined before the start of the forward/rearward travel switching action and then causes the motor controller 11b to change the rotation speed of the electric motor 3 according to the changed operation amount of the accelerator 19 to cause the vehicle body 2 to travel.

Alternatively, the controller 11 may update the target vehicle speed −Vt1, +Vt2 according to the changed operation amount of the accelerator 19 during the forward/rearward travel switching action. The controller 11 may then update the forward/rearward travel switching characteristics (at least one of the following: duration T1, T2, vehicle-speed change rate R1, R2, speed reduction time period T1d, T2d, speed increase time period T1i, T2i, speed reduction rate R1d, R2d, speed increase rate R1, R2i) according to the updated target vehicle speed −Vt1, +Vt2. The controller 11 may cause the motor controller 11b to control the rotation speed and the rotation direction of the electric motor 3 based on the updated forward/rearward travel switching characteristics to perform the forward/rearward travel switching action.

In the example in FIGS. 6A and 6B, the controller 11 determines the forward/rearward travel switching characteristics for the forward/rearward travel switching action when the initial vehicle speed +Vr1, −Vr2 before the start of the forward/rearward travel switching action is not 0 (zero), i.e., when the vehicle body 2 is traveling. Note, however, that the controller 11 may be configured or programmed to determine the forward/rearward travel switching characteristics for the forward/rearward travel switching action when the initial vehicle speed +Vr1, −Vr2 is 0, i.e., when the vehicle body 2 is in the stopped state, as shown in, for example, FIGS. 7A and 7B.

Specifically, in the case where the direction of travel of the vehicle body 2 is switched from forward to rearward while the vehicle body 2 is in the stopped state, the controller 11 causes the characteristics determiner 11f to determine at least one of the first duration T1 over which the vehicle speed changes from the initial vehicle speed +Vr1 of 0 (zero) to the rearward-travel target vehicle speed −Vt1, the first speed increase time period T1i (T1i=T1), the first vehicle-speed change rate R1, or the first speed increase rate R1 (R1i=R1), which are included in the forward/rearward travel switching characteristics (see FIG. 7A).

In the case where the direction of travel of the vehicle body 2 is switched from rearward to forward while the vehicle body 2 is in the stopped state, the controller 11 causes the characteristics determiner 11f to determine at least one of the second duration T2 over which the vehicle speed changes from the initial vehicle speed −Vr2 of 0 (zero) to the forward-travel target vehicle speed +Vt2, the second speed increase time period T2i (T2i=T2), the second vehicle-speed change rate R2, or the second speed increase rate R2i (R2i=R2), which are included in the forward/rearward travel switching characteristics (see FIG. 7B).

Even in the case where the absolute value of the initial vehicle speed +Vr1 when switching the direction of travel of the vehicle body 2 from forward to rearward and the absolute value of the initial vehicle speed −Vr2 when switching the direction of travel of the vehicle body 2 from rearward to forward are equal (|+Vr|=|−Vr2|) and the absolute value of the target vehicle speed −Vt1 when switching the direction of travel of the vehicle body 2 from forward to rearward and the absolute value of the target vehicle speed +Vt2 when switching the direction of travel of the vehicle body 2 from rearward to forward are equal (|−Vt1|=|+Vt2|), the controller 11 may cause the characteristics determiner 11f to define the first duration T1 and the second duration T2 such that the first duration T1 and the second duration T2 differ from each other.

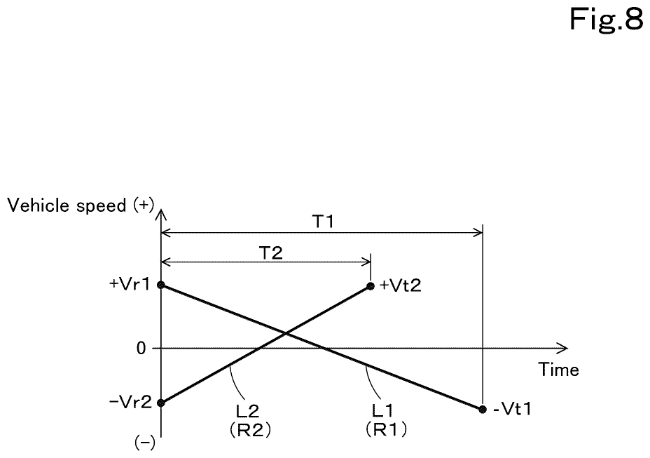

For example, the controller 11 may be configured or programmed to cause the characteristics determiner 11f to determine the first duration T1 and the second duration T2 such that the first duration T1 for switching the direction of travel of the vehicle body 2 from forward to rearward is longer than the second duration T2 for switching the direction of travel of the vehicle body 2 from rearward to forward (see FIG. 8). The controller 11 may be configured or programmed to cause the characteristics determiner 11f to determine the first vehicle-speed change rate R1 and the second vehicle-speed change rate R2 such that the first vehicle-speed change rate R1 for switching the direction of travel of the vehicle body 2 from forward to rearward is smaller than the second vehicle-speed change rate R2 for switching the direction of travel of the vehicle body 2 from rearward to forward. With this, even in the above-described case, the forward/rearward travel switching action to switch the direction of travel of the vehicle body 2 from forward to rearward is performed more slowly than the forward/rearward travel switching action to switch the direction of travel of the vehicle body 2 from rearward to forward.

The controller 11 may be configured or programmed to cause the characteristics determiner 11f to determine the first speed reduction rate R1d, the first speed increase rate R1, the first speed reduction time period T1d and the first speed increase time period T1i for switching the direction of travel of the vehicle body 2 from forward to rearward such that the first speed reduction rate Rid and the first speed increase rate R1i differ from each other and that the first speed reduction time period T1d and the first speed increase time period T1i differ from each other. Specifically, the controller 11, for example, causes the characteristics determiner if to multiply at least one of the determined first speed reduction rate R1d, first speed increase rate R1, first speed reduction time period T1d, or first speed increase time period T1i by a corresponding coefficient to modify it to obtain definitive first speed reduction rate R1d, first speed increase rate R1, first speed reduction time period T1d, and first speed increase time period T1i.

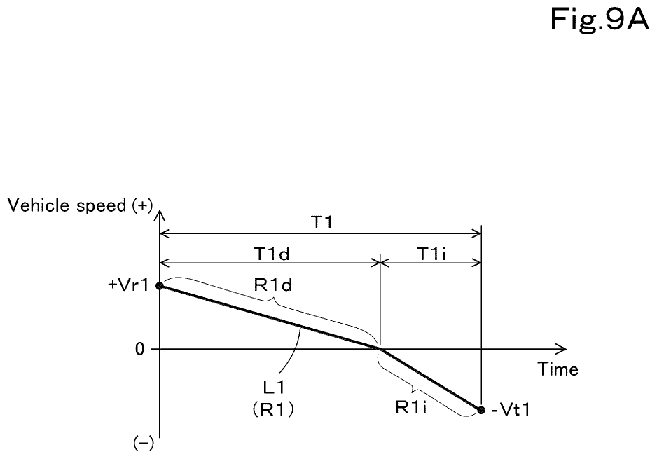

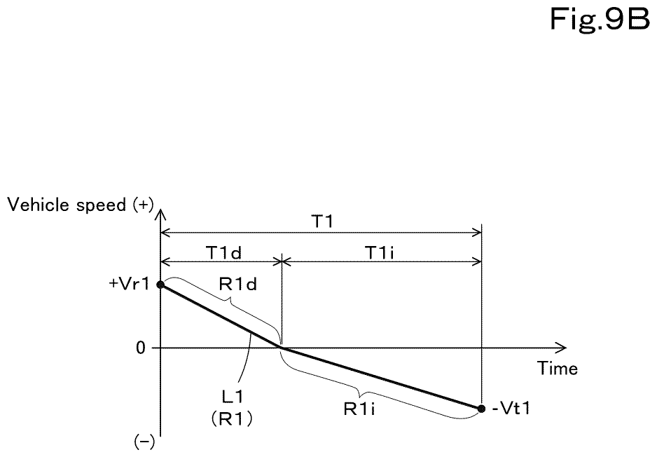

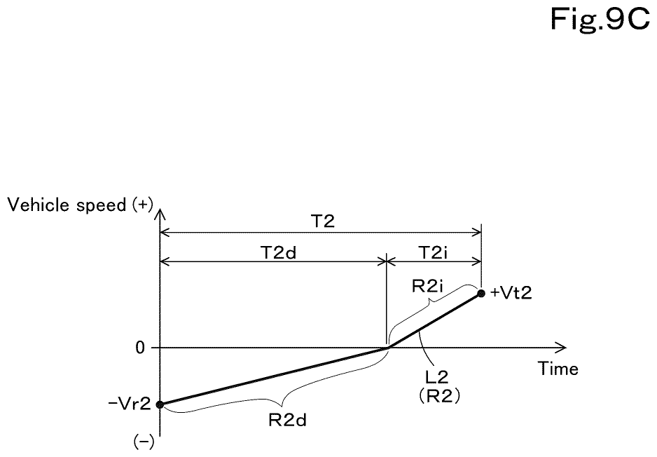

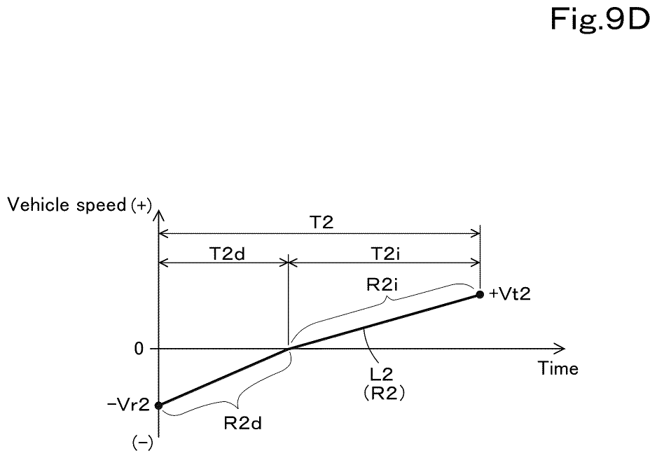

The controller 11 may be configured or programmed to determine the first speed reduction rate R1d, the first speed increase rate R1i, the first speed reduction time period T1d, and the first speed increase time period T1i such that the first speed reduction rate Rid is smaller than the first speed increase rate R1i and that the first speed reduction time period T1d is longer than the first speed increase time period T1i (see, for example, FIG. 9A). With this, the vehicle speed decreases from the initial vehicle speed +Vr1 of forward travel to 0 (zero) slowly, eliminating or reducing the likelihood that the vehicle body 2 will be subjected to a large inertia force and become unstable, and the vehicle speed increases from 0 (zero) to the rearward-travel target vehicle speed −Vt1 quickly, making it possible to perform (complete) the forward/rearward travel switching action for switching from forward travel to rearward travel stably and quickly.

The controller 11 may be configured or programmed to determine the first speed reduction rate R1d, the first speed increase rate R1i, the first speed reduction time period T1d and the first speed increase time period T1i such that the first speed reduction rate Rid is larger than the first speed increase rate R1i and that the first speed reduction time period T1d is shorter than the first speed increase time period T1i (see, for example, FIG. 9B). With this, the vehicle speed decreases from the initial vehicle speed +Vr1 of forward travel to 0 (zero) quickly, and the vehicle speed increases from 0 (zero) to the rearward-travel target vehicle speed −Vt1 slowly, making it possible to perform (complete) the forward/rearward travel switching action for switching from forward travel to rearward travel quickly and stably.

The controller 11 may be configured or programmed to cause the characteristics determiner 11f to determine the second speed reduction rate R2d, the second speed increase rate R2i, the second speed reduction time period T2d and the second speed increase time period T2i for switching the direction of travel of the vehicle body 2 from rearward to forward such that the second speed reduction rate R2d and the second speed increase rate R2i differ from each other and that second speed reduction time period T2d and the second speed increase time period T2i differ from each other. Specifically, the controller 11, for example, causes the characteristics determiner 11f to multiply at least one of the second speed reduction rate R2d, the second speed increase rate R2i, the second speed reduction time period T2d, or the second speed increase time period T2i by a corresponding coefficient to modify it to obtain definitive second speed reduction rate R2d, second speed increase rate R2i, second speed reduction time period T2d, and second speed increase time period T2i.

The controller 11 may be configured or programmed to determine the second speed reduction rate R2d, the second speed increase rate R2i, the second speed reduction time period T2d and the second speed increase time period T2i such that the second speed reduction rate R2d is smaller than the second speed increase rate R2i and that the second speed reduction time period T2d is longer than the second speed increase time period T2i (see, for example, FIG. 9C). With this, the vehicle speed decreases from the initial vehicle speed −Vr2 of rearward travel to 0 (zero) slowly, eliminating or reducing the likelihood that the vehicle body 2 will be subjected to a large inertia force and become unstable, and the vehicle speed increases from 0 (zero) to the forward-travel target vehicle speed +Vt2 quickly, making it possible to perform (complete) the forward/rearward travel switching action for switching from rearward travel to forward travel stably and quickly.

The controller 11 may be configured or programmed to determine the second speed reduction rate R2d, the second speed increase rate R2i, the second speed reduction time period T2d, and the second speed increase time period T2i such that the second speed reduction rate R2d is larger than the first speed increase rate R1 and that the second speed reduction time period T2d is shorter than the second speed increase time period T2i (see, for example, FIG. 9D). With this, the vehicle speed decreases from the initial vehicle speed −Vr2 of rearward travel to 0 (zero) quickly, and the vehicle speed increases from 0 (zero) to the forward-travel target vehicle speed +Vt2 slowly, making it possible to cause the vehicle body 2 to travel forward stably and thus possible to perform (complete) the forward/rearward travel switching action for switching from rearward travel to forward travel quickly and stably.

As described earlier, the status information inputted via the user interface 20, the internal sensor unit 21, the external sensor unit 22, the position detector 23, and/or the communicator 24 includes information indicating at least one of whether a person is in the working vehicle 1, the travel state of the working vehicle 1, the manner in which a working device 4 is connected or not connected to the vehicle body 2, the type of the working device 4 connected to the vehicle body 2, or the location at which the working vehicle 1 is located. The controller 11 may be configured or programmed to cause the characteristics determiner 11f to determine the forward/rearward travel switching characteristics based on the status information.

The controller 11 may be configured or programmed to cause the characteristics determiner 11f to determine the forward/rearward travel switching characteristics based on whether a predetermined condition relating to the status information about the working vehicle 1, the working device 4, and/or the surrounding environment is satisfied or not. The controller 11 may be configured or programmed to cause the characteristics determiner 11f to determine a coefficient based on whether the predetermined condition is satisfied or not, and determine (obtain definitive versions of) the forward/rearward travel switching characteristics (duration T1, T2, speed reduction time period T1d, T2d, speed increase time period T1i, T2i, vehicle-speed change rate R1, R2, speed reduction rate R1d, R2d, and/or speed increase rate R1, R2i) using the coefficient.

Examples of the predetermined condition are as follows. The controller 11 determines whether or not a person is in the working vehicle 1 based on the detected result from the person sensor 21a that is an example of the status information of the working vehicle 1. Alternatively, the controller 11 determines whether or not a person is in the working vehicle 1 based on at least one of the vehicle information received via the wide-area communicator 24c of the communicator 24, the vehicle information inputted via the user interface 20, or the vehicle information stored in advance in the memory 11a. The controller 11 then causes the characteristics determiner 11f to determine the forward/rearward travel switching characteristics such that the forward/rearward travel switching action is performed faster when it is determined that no persons are in the working vehicle 1 than when it is determined that a person is in the working vehicle 1.

Specifically, for example, as illustrated in FIG. 10A, in the case of the forward/rearward travel switching action to switch the direction of travel of the vehicle body 2 from forward to rearward, if a person is in the working vehicle 1, the controller 11 causes the characteristics determiner 11f to determine the first vehicle-speed change rate R1b and the first duration T1b as indicated by the characteristics line L1b. If no persons are in the working vehicle 1, the controller 11 causes the characteristics determiner 11f to determine the first vehicle-speed change rate Ria and the first duration T1a as indicated by the characteristics line L1a. The absolute value of the first vehicle-speed change rate R1a is larger than the absolute value of the first vehicle-speed change rate Rib, and the first duration T1a is shorter than the first duration T1b.

For example, as illustrated in FIG. 10B, in the case of the forward/rearward travel switching action to switch the direction of travel of the vehicle body 2 from rearward to forward, if a person is in the working vehicle 1, the controller 11 causes the characteristics determiner 11f to determine the second vehicle-speed change rate R2b and the second duration T2b as indicated by the characteristics line L2b. If no persons are in the working vehicle 1, the controller 11 causes the characteristics determiner 11f to determine the second vehicle-speed change rate R2a and the second duration T2a as indicated by the characteristics line L2a. The absolute value of the second vehicle-speed change rate R2a is larger than the absolute value of the second vehicle-speed change rate R2b, and the second duration T2a is shorter than the second duration T2b.

The characteristics line L1a in FIG. 10A is forward/rearward travel switching characteristics calculated by the controller 11 by multiplying, by a coefficient “1”, the slope of a basic characteristics line determined by the controller 11 based on the initial vehicle speed +Vr1 and the rearward-travel target vehicle speed −Vt1. That is, the characteristics line L1a is the same as the basic characteristics line. The characteristics line L1b is forward/rearward travel switching characteristics calculated by the controller 11 by multiplying the slope of the basic characteristics line by a coefficient greater than “1” (e.g., “1.2”). The characteristics line L2a in FIG. 10B is forward/rearward travel switching characteristics calculated by the controller 11 by multiplying, by a coefficient “1”, the slope of a basic characteristics line determined by the controller 11 based on the initial vehicle speed −Vr2 and the forward-travel target vehicle speed +Vt2. That is, the characteristics line L2a is the same as the basic characteristics line. The characteristics line L2b is forward/rearward travel switching characteristics calculated by the controller 11 by multiplying the basic characteristics line by a coefficient greater than “1” (e.g., “1.2”).

Further examples of the predetermined condition are as follows. The controller 11 determines whether the vehicle body 2 is traveling straight or turning based on at least one of the steering angle detected by the steering angle sensor 21b, the yaw angle (steering angle) calculated from the detected result from the IMU 21d, or time-series data about the position detected by the position detector 23, which are examples of the status information of the working vehicle 1. The controller 11 then causes the characteristics determiner 11f to determine the forward/rearward travel switching characteristics such that the forward/rearward travel switching action is performed faster when it is determined that the vehicle body 2 is traveling straight than when it is determined that the vehicle body 2 is turning.

Specifically, for example, as illustrated in FIG. 10A, in the case of the forward/rearward travel switching action to switch the direction of travel of the vehicle body 2 from forward to rearward, if the vehicle body 2 is turning, the controller 11 determines the first vehicle-speed change rate R1b and the first duration T1b as indicated by the characteristics line L1b, and, if the vehicle body 2 is traveling straight, determines the first vehicle-speed change rate R1a and the first duration T1a as indicated by the characteristics line L1a. As illustrated in FIG. 10B, in the case of the forward/rearward travel switching action to switch the direction of travel of the vehicle body 2 from rearward to forward, if the vehicle body 2 is turning, the controller 11 determines the second vehicle-speed change rate R2b and the second duration T2b as indicated by the characteristics line L2b, and if the vehicle body 2 is traveling straight, determines the second vehicle-speed change rate R2a and the second duration T2a as indicated by the characteristics line L2a.

Further examples of the predetermined condition are as follows. The controller 11 determines whether or not a working device 4 is connected to the vehicle body 2 based on at least one of the load detected by the load sensor 21e, the detection result about an area rearward of the vehicle body 2 from the laser sensor 22a, or an image of the area rearward of the vehicle body 2 captured by the camera 22c, which are examples of the status information of the working device 4. Alternatively, the controller 11 determines whether or not a working device 4 is connected to the vehicle body 2 based on whether or not the device information of the working device 4 is received via at least one of the wired communication port 24a of the communicator 24 or the short-range communicator 24b of the communicator 24.

Alternatively, the controller 11 determines whether or not a working device 4 is connected to the vehicle body 2 based on whether or not the device information of the working device 4 connected to the vehicle body 2 is inputted via the user interface 20. The controller 11 then causes the characteristics determiner 11f to determine the forward/rearward travel switching characteristics such that the forward/rearward travel switching action is performed faster when it is determined that no working devices 4 are connected to the vehicle body 2 than when it is determined that a working device 4 is connected to the vehicle body 2.

Specifically, for example, as illustrated in FIG. 10A, in the case of the forward/rearward travel switching action to switch the direction of travel of the vehicle body 2 from forward to rearward, if a working device 4 is connected to the vehicle body 2, the controller 11 determines the first vehicle-speed change rate R1b and the first duration T1b as indicated by the characteristics line L1b, and, if no working devices 4 are connected to the vehicle body 2, determines the first vehicle-speed change rate R1a and the first duration T1a as indicated by the characteristics line L1a. As illustrated in FIG. 10B, in the case of the forward/rearward travel switching action to switch the direction of travel of the vehicle body 2 from rearward to forward, if a working device 4 is connected to the vehicle body 2, the controller 11 determines the second vehicle-speed change rate R2b and the second duration T2b as indicated by the characteristics line L2b, and if no working devices 4 are connected to the vehicle body 2, determines the second vehicle-speed change rate R2a and the second duration T2a as indicated by the characteristics line L2a.

Further examples of the predetermined condition are as follows. The controller 11 determines the type of the working device 4 connected to the vehicle body 2 based on at least one of the detected result from the load sensor 21e, the detected result from the laser sensor 22a, or an image captured by the camera 22c, and determines whether or not the type is a predetermined type. Alternatively, the controller 11 determines the type of the working device 4 connected to the vehicle body 2 based on the device information received via the wired communication port 24a or the short-range communicator 24b, the device information inputted via the user interface 20, or the device information stored in advance in the memory 11a, and determines whether or not the type is a predetermined type. The controller 11 then causes the characteristics determiner 11f to determine the forward/rearward travel switching characteristics such that the forward/rearward travel switching action is performed faster when it is determined that the type of the working device 4 connected to the vehicle body 2 is a predetermined type than when it is determined that the type of the working device 4 connected to the vehicle body 2 is not the predetermined type.

Specifically, the controller 11 determines whether the type of the working device 4 connected to the vehicle body 2 is a directly attached working device or a towed working device, for example. As illustrated in FIG. 10A, in the case of the forward/rearward travel switching action to switch the direction of travel of the vehicle body 2 from forward to rearward, if the working device 4 is a towed working device, the controller 11 determines the first vehicle-speed change rate R1b and the first duration T1b as indicated by the characteristics line L1b, and, if the working device 4 is a directly attached working device, determines the first vehicle-speed change rate R1a and the first duration T1a as indicated by the characteristics line L1a.

As illustrated in FIG. 10B, in the case of the forward/rearward travel switching action to switch the direction of travel of the vehicle body 2 from rearward to forward, if the working device 4 is a towed working device, the controller 11 determines the second vehicle-speed change rate R2b and the second duration T2b as indicated by the characteristics line L2b, and if the working device 4 is a directly attached working device, determines the second vehicle-speed change rate R2a and the second duration T2a as indicated by the characteristics line L2a.

That is, the absolute values of the first vehicle-speed change rate R1a and the second vehicle-speed change rate R2a determined when the working device 4 is a directly attached working device are greater than the absolute values of the first vehicle-speed change rate R1b and the second vehicle-speed change rate R2b determined when the working device 4 is a towed working device. The first duration T1a and the second duration T2a determined when the working device 4 is a directly attached working device are shorter than the first duration T1b and the second duration T2b determined when the working device 4 is a towed working device.

The controller 11 determines whether the type of the working device 4 connected to the vehicle body 2 is a lightweight working device or a heavyweight working device. As illustrated in FIG. 10A, in the case of the forward/rearward travel switching action to switch the direction of travel of the vehicle body 2 from forward to rearward, if the working device 4 is a heavyweight working device, the controller 11 determines the first vehicle-speed change rate R1b and the first duration T1b as indicated by the characteristics line L1b, and, if the working device 4 is a lightweight working device, determines the first vehicle-speed change rate R1a and the first duration T1a as indicated by the characteristics line L1a.

As illustrated in FIG. 10B, in the case of the forward/rearward travel switching action to switch the direction of travel of the vehicle body 2 from rearward to forward, if the working device 4 is a heavyweight working device, the controller 11 determines the second vehicle-speed change rate R2b and the second duration T2b as indicated by the characteristics line L2b, and if the working device 4 is a lightweight working device, determines the second vehicle-speed change rate R2a and the second duration T2a as indicated by the characteristics line L2a.

That is, the absolute values of the first vehicle-speed change rate R1a and the second vehicle-speed change rate R2a determined when the working device 4 is a lightweight working device are greater than the absolute values of the first vehicle-speed change rate R1b and the second vehicle-speed change rate R2b determined when the working device 4 is a heavyweight working device. The first duration T1a and the second duration T2a determined when the working device 4 is a lightweight working device are shorter than the first duration T1b and the second duration T2b determined when the working device 4 is a heavyweight working device.

The controller 11 determines at least one of a geographic feature or the size of a location in which the vehicle body 2 is located, based on at least one of the pitch angle of the vehicle body 2 calculated from the detected result from the IMU 21d that is an example of the status information of the working vehicle 1, the detected result from the laser sensor 22a that is an example of the status information of the surrounding environment of the working vehicle 1, or an image captured by the camera 22c that is an example of the status information of the surrounding environment of the working vehicle 1. Alternatively, the controller 11 determines at leas one of a geographic feature or the size of a location in which the vehicle body 2 is located, based on the position detected by the position detector 23 that is an example of the status information of the working vehicle 1 and based on the map information about the location where the vehicle body 2 is located received via the wide-area communicator 24c of the communicator 24 or stored in advance in the memory 11a. The controller 11 then causes the characteristics determiner 11f to determine the forward/rearward travel switching characteristics based on the determined at least one of he geographic feature or the size of the location.

More specific examples of the predetermined condition are as follows. The controller 11 determines whether or not the vehicle body 2 is traveling on a level ground or a sloping ground based on the above-described status information, and, if determining that the vehicle body 2 is traveling on a sloping ground, further determines whether the vehicle body 2 is traveling up the sloping ground or down the sloping ground.

The controller 11 then determines the forward/rearward travel switching characteristics such that the forward/rearward travel switching action is performed faster when it is determined that the vehicle body 2 is traveling on the level ground and when it is determined that the vehicle body 2 is traveling down the sloping ground than when it is determined that the vehicle body 2 is traveling up the sloping ground. Specifically, as illustrated in FIG. 10A, in the case of the forward/rearward travel switching action to switch the direction of travel of the vehicle body 2 from forward to rearward, if the vehicle body 2 is traveling up the sloping ground, the controller 11 determines the first vehicle-speed change rate R1b and the first duration T1b as indicated by the characteristics line L1b, and, if the vehicle body 2 is traveling on the level ground or the vehicle body 2 is traveling down the sloping ground, determines the first vehicle-speed change rate R1a and the first duration T1a as indicated by the characteristics line L1a.

As illustrated in FIG. 10B, in the case of the forward/rearward travel switching action to switch the direction of travel of the vehicle body 2 from rearward to forward, if the vehicle body 2 is traveling up the sloping ground, the controller 11 determines the second vehicle-speed change rate R2b and the second duration T2b as indicated by the characteristics line L2b, and if the vehicle body 2 is traveling on the level ground or the vehicle body 2 is traveling down the sloping ground, determines the second vehicle-speed change rate R2a and the second duration T2a as indicated by the characteristics line L2a.

That is, the absolute values of the first vehicle-speed change rate R1a and the second vehicle-speed change rate R2a determined when the vehicle body 2 is traveling on the level ground or traveling down the sloping ground are greater than the absolute values of the first vehicle-speed change rate R1b and the second vehicle-speed change rate R2b determined when the vehicle body 2 is traveling up the sloping ground. The first duration T1a and the second duration T2a determined when the vehicle body 2 is traveling on the level ground or traveling down the sloping ground are shorter than the first duration T1b and the second duration T2b determined when the vehicle body 2 is traveling up the sloping ground.

As another example, the absolute values of the first vehicle-speed change rate R1a and the second vehicle-speed change rate R2a determined when the vehicle body 2 is traveling down the sloping ground may be smaller than the absolute values of the first vehicle-speed change rate R1a and the second vehicle-speed change rate R2a determined when the vehicle body 2 is traveling on the level ground. The first duration T1a and the second duration T2a determined when the vehicle body 2 is traveling down the sloping ground may be longer than the first duration T1a and the second duration T2a determined when the vehicle body 2 is traveling on the level ground.

The controller 11 may be configured or programmed to, if it is determined that the vehicle body 2 is traveling on a level ground, determine the forward/rearward travel switching characteristics such that the first duration T1 for switching the direction of travel of the vehicle body 2 from forward to rearward is longer than the second duration T2 for switching the direction of travel of the vehicle body 2 from rearward to forward such that the forward/rearward travel switching action to switch the direction of travel of the vehicle body 2 from forward to rearward is performed more slowly than the forward/rearward travel switching action to switch the direction of travel of the vehicle body 2 from rearward to forward (see FIG. 8).

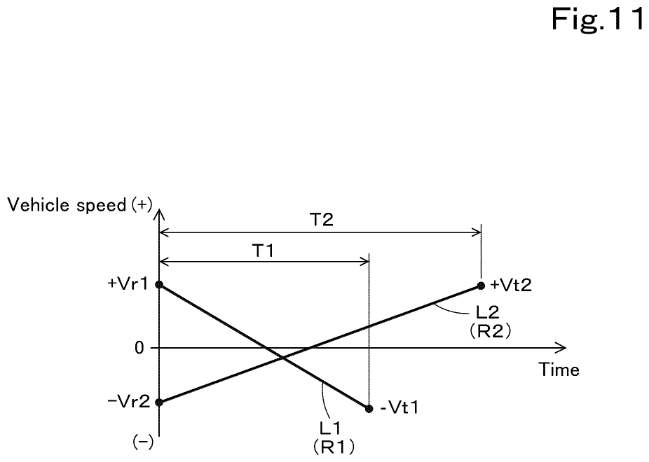

The controller 11 may be configured or programmed to, when it is determined that the vehicle body 2 is traveling down the sloping ground, determine the forward/rearward travel switching characteristics such that the second duration T2 for switching the direction of travel of the vehicle body 2 from rearward to forward is longer than the first duration T1 for switching the direction of travel of the vehicle body 2 from forward to rearward such that the forward/rearward travel switching action to switch the direction of travel of the vehicle body 2 from rearward to forward is performed more slowly than the forward/rearward travel switching action to switch the direction of travel of the vehicle body 2 from forward to rearward (see, for example, FIG. 11).

The controller 11 compares the position (of the vehicle body 2) detected by the position detector 23 with the agricultural field information, and determines whether or not the detected position is in the headland E1 (see FIG. 5) located between the work area C1 of the agricultural field H1 and the edge (contour) H2 of the agricultural field H1 indicated by the agricultural field information received via the wide-area communicator 24c of the communicator 24 or stored in advance in the memory 11a. The controller 11 then, if the position detected by the position detector 23 is within the headland E1, calculates the headland width D2 of the headland E1 that is the distance from the work area C1 to the edge H2 of the agricultural field H1 based on the agricultural information, and determines the forward/rearward travel switching characteristics such that the forward/rearward travel switching action is performed more slowly when the headland width D2 is less than a fourth predetermined value than when the headland width D2 is equal to or greater than the fourth predetermined value. Note that the fourth predetermined value is defined to be smaller than the foregoing second predetermined value based on which the point in time at which the forward/rearward travel switching action is to be performed is determined.

As illustrated in FIG. 10A, in the case of the forward/rearward travel switching action to switch the direction of travel of the vehicle body 2 from forward to rearward, if the headland width D2 is less than the fourth predetermined value, the controller 11 determines the first vehicle-speed change rate R1b and the first duration T1b as indicated by the characteristics line L1b, and, if the headland width D2 is equal to or greater than the fourth predetermined value, determines the first vehicle-speed change rate R1a and the first duration T1a as indicated by the characteristics line L1a. As illustrated in FIG. 10B, in the case of the forward/rearward travel switching action to switch the direction of travel of the vehicle body 2 from rearward to forward, if the headland width D2 is less than the fourth predetermined value, the controller 11 determines the second vehicle-speed change rate R2b and the second duration T2b as indicated by the characteristics line L2b, and if the headland width D2 is equal to or greater than the fourth predetermined value, determines the second vehicle-speed change rate R2a and the second duration T2a as indicated by the characteristics line L2a.

That is, the absolute values of first vehicle-speed change rate R1b and the second vehicle-speed change rate R2b determined when the headland width D2 is less than the fourth predetermined value are smaller than the absolute values of the first vehicle-speed change rate R1a and the second vehicle-speed change rate R2a determined when the headland width D2 is equal to or greater than the fourth predetermined value. The first duration T1b and the second duration T2b determined when the headland width D2 is less than the fourth predetermined value are longer than the first duration T1a and the second duration T2a determined when the headland width D2 is equal to or greater than the fourth predetermined value.

Condition(s) other than the above-described conditions relating to the status information may be defined in advance, and the controller 11 may be configured or programmed to cause the characteristics determiner 11f to determine the forward/rearward travel switching characteristics based on whether or not the other condition(s) is/are satisfied.

For example, the controller 11 may be configured or programmed to refer to the operating time indicated by an hour meter that is an example of the status information of the working vehicle 1, to take into consideration the wear status and the health status of elements to perform the forward/rearward travel switching action of the working vehicle 1 such as the traveling device 5, the electric motor 3, the inverter 14, and the high-voltage battery 12. The controller 11 may be configured or programmed to cause the characteristics determiner 11f to determine the forward/rearward travel switching characteristics (first duration, second duration, first vehicle-speed change rate, second vehicle-speed change rate, etc.) such that the forward/rearward travel switching action is performed more slowly when the operating time indicated by the hour meter is equal to or longer than a predetermined time than when the operating time indicated by the hour meter is less than the predetermined time.

The controller 11 determines whether or not the working device 4 connected to the vehicle body 2 is in contact with the ground based on, for example, the lifting switch of the working vehicle 1 or an image captured by the camera 22c. The controller 11 may be configured or programmed to determine the forward/rearward travel switching characteristics such that the forward/rearward travel switching action is performed more quickly when it is determined that the working device 4 is in contact with the ground than when it is determined that the working device 4 is not in contact with the ground.

The controller 11 may be configured or programmed to, based on the detected result from the laser sensor 22a, based on an image captured by the camera 22c, or based on the position detected by the position detector 23 and the map information, determine the forward/rearward travel switching characteristics such that the forward/rearward travel switching action is performed more quickly when the distance between the vehicle body 2 and an obstacle or the size of the location where the vehicle body 2 is located is equal to or greater than a predetermined value than when the distance between the vehicle body 2 and an obstacle or the size of the location where the vehicle body 2 is located is less than the predetermined value.

In the example embodiments described so far, the working device 4 is connected to the rear portion of the vehicle body 2 via the linkage 6. Note, however, that a working device such as a bucket can be connected to a front portion of the vehicle body 2 via, for example, a front loader. In consideration of the above, the controller 11 may be configured or programmed to determine whether the working device 4 is connected to the front portion or the rear portion of the vehicle body 2 based on, for example, at least one of the detected result from the laser sensor 22a, an image captured by the camera 22c, or the device information inputted via the user interface 20 or the communicator 24. The controller 11 may be configured or programmed to then determine the forward/rearward travel switching characteristics such that, for example, the forward/rearward travel switching action is performed more quickly when it is determined that the working device 4 is connected to the front portion of the vehicle body 2 than when it is determined that the working device 4 is connected to the rear portion of the vehicle body 2.

Specifically, for example, as illustrated in FIG. 10A, in the case of the forward/rearward travel switching action to switch the direction of travel of the vehicle body 2 from forward to rearward, if the working device 4 is connected to the rear portion of the vehicle body 2, the controller 11 determines the first vehicle-speed change rate R1b and the first duration T1b as indicated by the characteristics line L1b. If the working device 4 is connected to the front portion of the vehicle body 2, the controller 11 determines the first vehicle-speed change rate R1a and the first duration T1a as indicated by the characteristics line L1a. As illustrated in FIG. 10B, in the case of the forward/rearward travel switching action to switch the direction of travel of the vehicle body 2 from rearward to forward, if the working device 4 is connected to the rear portion of the vehicle body 2, the controller 11 determines the second vehicle-speed change rate R2b and the second duration T2b as indicated by the characteristics line L2b. If the working device 4 is connected to the front portion of the vehicle body 2, the controller 11 determines the second vehicle-speed change rate R2a and the second duration T2a as indicated by the characteristics line L2a.

One of the above-described conditions relating to the status information may be defined on the working vehicle 1. Two or more of the above-described conditions relating to the status information may be defined on the working vehicle 1.

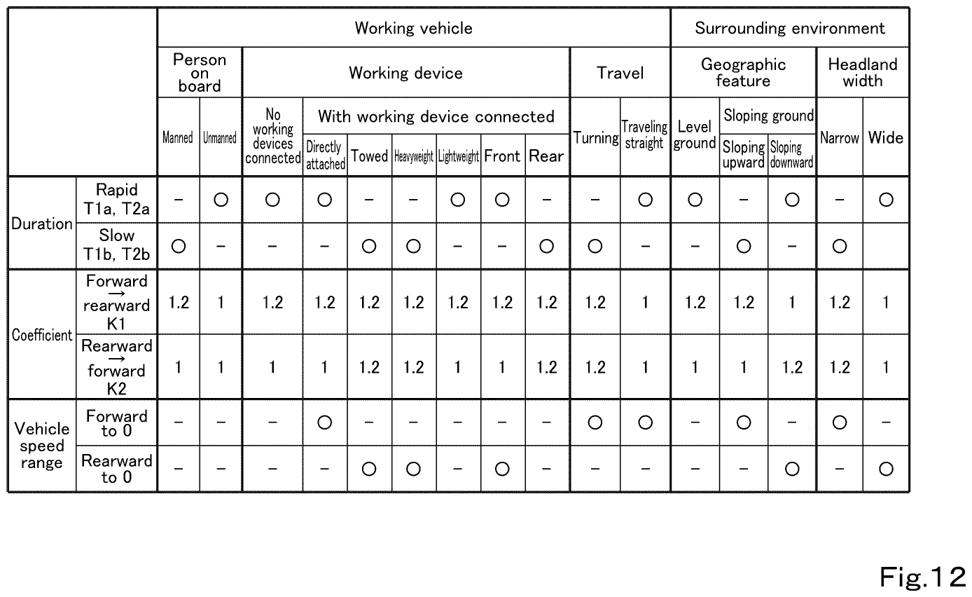

FIG. 12 is a table showing an example of the relationship between a plurality of conditions relating to status information and forward/rearward travel switching characteristics. In the example shown in FIG. 12, the conditions relating to the status information of the working vehicle 1 include “Manned” indicating that a person is in the working vehicle 1, “Unmanned” indicating that no persons are in the working vehicle 1, and “Turning” and “Traveling straight” of the vehicle body 2. The conditions relating to the status information of the working device 4 include “No working device connected” indicating that no working devices 4 are connected to the vehicle body 2, “With working device connected” indicating that a working device 4 is connected to the vehicle body 2, “Directly attached”, “Towed”, “Heavyweight”, and “Lightweight” which are the types of working devices 4, and “Front” and “Rear” at which the working device 4 is connected to the vehicle body 2. The conditions relating to the status information of the surrounding environment include “Level ground”, “Traveling up slope” and “Traveling down slope” of “Sloping ground” which are geographic features of the location where the vehicle body 2 is located, “Narrow” indicating that the headland width D2 of the headland E1 where the vehicle body 2 is located is less than the fourth predetermined value, and “Wide” indicating that the headland width D2 of the headland E1 where the vehicle body 2 is located is equal to or greater than the fourth predetermined value.

There are set related values for use in determining the durations T1, T2 of the forward/rearward travel switching actions included in the forward/rearward travel switching characteristics. The related values include “rapid duration T1a, T2a” and “slow duration T1b, T2b” shown in FIGS. 10A and 10B, “coefficient K1” by which the first duration T1 is multiplied, “coefficient K2” by which the second duration T2 is multiplied, and the vehicle speed ranges each indicating whether the vehicle speed is changed more quickly in the range “Forward to 0” or “Rearward to 0” in the duration T1, T2.

In the case where the condition(s) “Unmanned”, “With no working devices connected”, “Directly attached”, “Lightweight”, “Front”, “Traveling straight”, “Level ground”, “Traveling down slope”, and/or “Wide”, of the plurality of conditions, is/are satisfied, the controller 11 causes the characteristics determiner 11f to determine the rapid duration(s) T1a, T2a as shown in FIGS. 10A and 10B (which is/are “first values”) that are/is related value(s) for determining the duration(s) T1, T2. In the case where the condition(s) “Manned”, “Towed”, “Heavyweight”, “Rear”, “Turning”, “Traveling up slope”, and/or “Narrow”, of the plurality of conditions, is/are satisfied, the controller 11 causes the characteristics determiner 11f to determine the slow duration(s) T1b, T2b shown in FIGS. 10A and 10B (which is/are “second value(s)”) that is/are related value(s) for use in determining the duration(s) T1, T2.

In the case where the condition(s) “Manned”, “No working devices connected”, “Directly attached”, “Towed”, “Heavyweight”, “Lightweight”, “Front”, “Rear”, “Turning”, “Level ground”, “Traveling up slope”, and/or “Narrow”, of the plurality of conditions, is/are satisfied, the controller 11 causes the characteristics determiner 11f to determine that the “coefficient K1”, which is a related value for use in determining the first duration T1, is “1.2” to make the first duration T1 longer (which is a “second value”). In the case where the condition(s) “Unmanned”, “Traveling straight”, “Traveling down slope”, and/or “Wide”, of the plurality of conditions, is/are satisfied, the controller 11 causes the characteristics determiner 11f to determine that the “coefficient K1” is “1” to make the first duration T1 short (which is a “first value”).

In the case where the condition(s) “Manned”, “Unmanned”, “No working devices connected”, “Directly attached”, “Lightweight”, “Front”, “Traveling straight”, “Level ground”, “Traveling up slope”, and/or “Wide”, of the plurality of conditions, is/are satisfied, the controller 11 causes the characteristics determiner 11f to determine that the “coefficient K2”, which is a related value for use in determining the second duration T2, is “1” to make the second duration T2 short. In the case where the condition(s) “Towed”, “Heavyweight”, “Rear”, “Turning”, “Traveling down slope”, and/or “Narrow”, of the plurality of conditions, is/are satisfied, the controller 11 causes the characteristics determiner 11f to determine that the “coefficient K2” is “1.2” to make the second duration T2 long.

In the case where the condition(s) “Directly attached”, “Turning”, “Traveling straight”, “Traveling up slope”, and/or “Narrow”, of the plurality of conditions, is/are satisfied, the controller 11 causes the characteristics determiner 11f to determine to change the vehicle speed more quickly in the range “Forward to 0” (which is a first value, represented by a circle) than in the range “Rearward to 0” (which is a second value, with no circles), which are included in each duration T1, T2. In the case where the condition(s) “Towed”, “Heavyweight”, “Front”, “Traveling down slope”, and/or “Wide”, of the plurality of conditions, is/are satisfied, the controller 11 causes the characteristics determiner 11f to determine to change the vehicle speed more quickly in the range “Rearward to 0” than in the range “Forward to 0” which are included in each duration T1, T2.

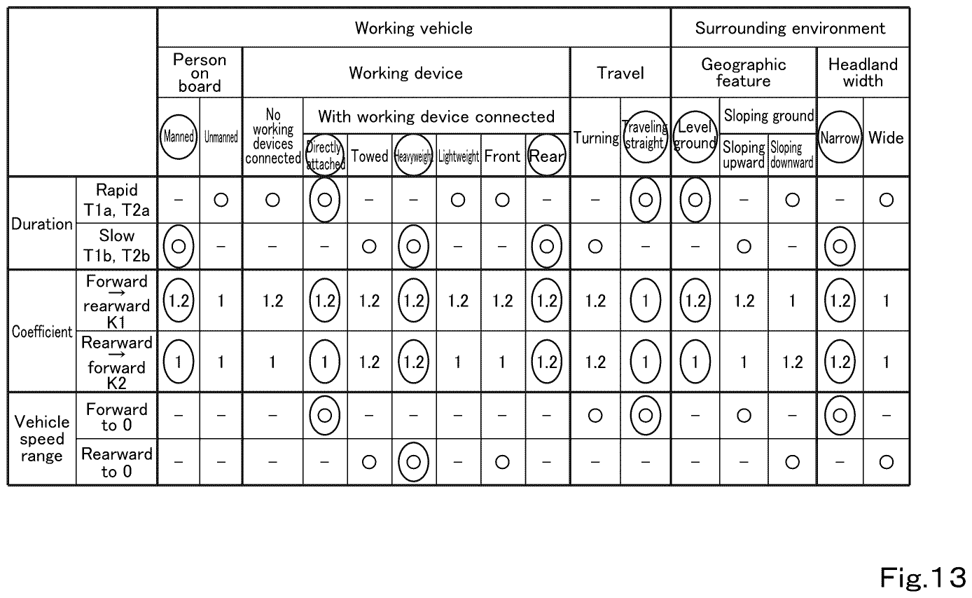

However, for example, as illustrated in FIG. 13, in the case where a plurality of conditions each enclosed by an ellipse are satisfied, the determined related values for use in determining the durations T1, T2 include both the “rapid duration T1a, T2a” (first value) and the “slow duration T1b, T2b” (second value), and therefore a definitive related value cannot be decided. Furthermore, the determined related values for use in determining (calculating) the durations T1, T2 include both the “coefficient K1” of “1” (first value) and the “coefficient K1” of “1.5” (second value), and both the “coefficient K2” of “1” (first value) and the “coefficient K2” of “1.5” (second value), and therefore a definitive related value cannot be decided. Furthermore, the determined ranges of the duration T1, T2 in which the vehicle speed is changed quicker include both the “Forward to 0” and the “Rearward to 0” (circles each indicate a first value, and cells with no circles each indicate a second value), and therefore a definitive range cannot be decided. To address this, the controller 11 is configured or programmed to determine a related value for use in determining the duration T1, T2 based on a predetermined selection method.

For example, the controller 11 determines whether or not a plurality of conditions are satisfied based on pieces of status information, and provisionally determines a rapid duration T1a, T2a (first value) or a slow duration T1b, T2b (second value) each of which is a related value for use in determining a duration T1, T2 and which corresponds to whether the corresponding condition is satisfied or not. The controller 11 then, if the provisionally determined related values include one or more instances of the rapid duration T1a, T2a and one or more instances of the slow duration T1b, T2b, determines that the rapid duration T1a, T2a or the slow duration T1b, T2b the number of instances of which is larger than the other is a definitively determined related value for use in determining the duration T1, T2 (majority method). In the example in FIG. 13, the controller 11 provisionally determines three instances of the rapid duration T1a, T2a and four instances of the slow duration T1b, T2b, and therefore the controller 11 determines that the slow duration T1b, T2b is a definitively determined related value for use in determining the duration T1, T2.

Alternatively, the controller 11, if each of the provisionally determined related values is the rapid duration T1a, T2a (first value), determines that the rapid duration T1a, T2a is a definitively determined related value for use in determining the duration T1, T2 (AND method). As illustrated in FIG. 13, the controller 11, if the provisionally determined related values include one or more instances of the rapid duration T1a, T2a and one or more instances of the slow duration T1b, T2b, determines that the slow duration T1b, T2b is a definitively determined related value for use in determining the duration T1, T2.

Alternatively, the controller 11 assigns N points (N is an integer, e.g., 3) to a related value provisionally determined based on a dynamic condition (whether the dynamic condition is satisfied is variable during travel of the vehicle body 2) of a plurality of conditions, and assigns M points (M is an integer, e.g., 1) to a related value provisionally determined based on a static condition (whether the static condition is satisfied is not variable during travel of the vehicle body 2) of the plurality of conditions, where M is less than N. In the example in FIG. 13, the conditions “Turning”, “Traveling straight”, “Level ground”, “Traveling up slope”, “Traveling down slope”, “Narrow”, and “Wide” are dynamic conditions, and the conditions “Manned”, “Unmanned”, “No working devices connected”, “Directly attached”, “Towed”, “Heavyweight”, “Lightweight”, “Front”, and “Rear” are static conditions.

As illustrated in FIG. 13, the controller 11, if the provisionally determined related values include one or more instances of the rapid duration T1a, T2a and one or more instances of the slow duration T1b, T2b, calculates the total number of points assigned to the instances of the rapid duration T1a, T2a and the total number of points assigned to the instances of the slow duration T1b, T2b. The controller 11 then determines that the rapid duration T1a, T2a or the slow duration T1b, T2b the number of points of which is greater than the other is a definitively determined related value for use in determining the duration T1, T2 (point method).

In the example in FIG. 13, the controller 11 provisionally determines the rapid duration T1a, T2a for the static condition “Directly attached” and the dynamic conditions “Traveling straight” and “Level ground”, and therefore the controller 11 determines that the total number of points assigned to the instances of the rapid duration T1a, T2a is 7 (i.e., the sum of 1, 3, and 3 points). Furthermore, the controller 11 provisionally determines the slow duration T1b, T2b for the static conditions “Manned”, “Heavyweight”, and “Rear” and the dynamic condition “Narrow”, the controller 11 determines that the total number of points assigned to the instances of the slow duration T1b, T2b is 6 (i.e., the sum of 1, 1, 1, and 3 points). Since the total number of points assigned to the instances of the rapid duration T1a, T2a is greater than the total number of points assigned to the instances of the slow duration T1b, T2b, the controller 11 determines that the rapid duration T1a, T2a is a definitively determined related value for use in determining the duration T1, T2.

The above-described three selection methods are merely examples, and a related value for use in determining the duration T1, T2 may be selected by some other method. For example, different degrees of priority are given to a plurality of conditions, and the controller 11 may be configured or programmed to select a related value corresponding to one of the satisfied conditions that is with the highest degree of priority. The controller 11 also determines a definitive “coefficient K1”, a definitive “coefficient K2”, and definitive ranges “Forward to 0” and “Rearward to 0” in which the vehicle speed is changed quicky, each using any of the three selection methods in a similar manner.

In the above-described example embodiments, the controller 11 automatically causes the characteristics determiner 11f to determine the forward/rearward travel switching characteristics based on the initial vehicle speed, the target vehicle speed, and the status information. Additionally or alternatively, a configuration in which the user is allowed to input any characteristics value included in the forward/rearward travel switching characteristics via the user interface 20 may be used, for example.

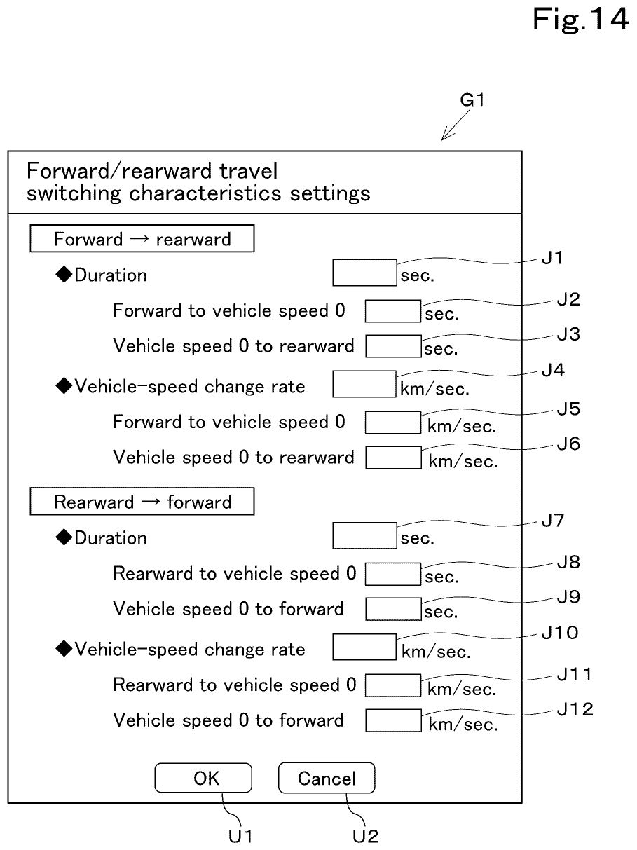

FIG. 14 illustrates an example of a settings screen G1 for forward/rearward travel switching characteristics. Upon the user such as the driver of the working vehicle 1 performing predetermined operation on the user interface 20, the controller 11 causes the display of the user interface 20 to display the settings screen G1 for forward/rearward travel switching characteristics.

The settings screen G1 includes input boxes J1 to J6 for input of the forward/rearward travel switching characteristics which are the first duration T1, the first speed reduction time period T1d, the first speed increase time period T1i, the first vehicle-speed change rate R1, the first speed reduction rate R1d, and the first speed increase rate R1 of the forward/rearward travel switching action to switch the direction of travel of the vehicle body 2 from forward to rearward. The settings screen G1 includes input boxes J7 to J12 for input of the forward/rearward travel switching characteristics which are the second duration T2, the second speed reduction time period T2d, second speed increase time period T2i, second vehicle-speed change rate R2, second speed reduction rate R2d, and the second speed increase rate R2i of the forward/rearward travel switching action to switch the direction of travel of the vehicle body 2 from rearward to forward. The settings screen G1 also includes an OK key U1 and a cancel key U2.

When the user taps one of the input boxes J1 to J12, the controller 11 causes a numeric keypad to be displayed on the settings screen G1 in a pop-up manner. In so doing, the controller 11 may cause the previously set characteristics values to be displayed in the input boxes J1 to J12. The user enters a desired characteristics value corresponding to the tapped input box J1 to J12 by tapping the numeric keypad, causing the controller 11 to cause the entered value to be displayed in the corresponding input box J1 to J12. The user then taps the OK key U1 to cause the controller 11 to store the value(s) displayed in the input box(es) J1 to J12, which are entered characteristics value(s) (changed characteristics value(s)), in the memory 11a. After that, the controller 11 determines or changes the forward/rearward travel switching characteristics based on the characteristics value(s) stored in the memory 11a when an instruction to perform the forward/rearward travel switching action is inputted or when it is determined that the forward/rearward travel switching action is to be performed.

Working vehicles according to example embodiments as has been discussed include features in the following items and achieve the following effects.

(Item 1) A working vehicle 1 including an electric motor 3 in or on a vehicle body 2, a traveling device 5 to be driven by power from the electric motor 3 to cause the vehicle body 2 to travel, a first input interface (at least one of user interface 20, rotation speed sensor 21a, steering angle sensor 21b, IM 21d, load sensor 21e, laser sensor 22a, camera 22c, position detector 23, or communicator 24) to receive input of status information indicating a state of at least one of the working vehicle 2 or a surrounding environment of the working vehicle 2, and a controller 11 configured or programmed to determine, based on the status information, a duration T1, T2 of a forward/rearward travel switching action to change a direction of travel of the vehicle body 2 from forward to rearward or from rearward to forward, and control driving of the electric motor 3 to perform, via the traveling device 5, the forward/rearward travel switching action over the determined duration T1, T2.

With the configuration of item 1, it is possible to determine the duration T1, T2 of the forward/rearward travel switching action depending on at least one of the state of the working vehicle 1 or the state of the surrounding environment of the working vehicle 1 and appropriately control the rapidity of the forward/rearward travel switching action of the working vehicle 1 using the determined duration T1, T2. This makes it possible to stably and appropriately perform the forward/rearward travel switching action of the working vehicle 1.

(Item 2) The working vehicle 1 according to item 1, further including an inverter 14 to drive the electric motor 3, wherein the controller 11 is configured or programmed to, while the vehicle body 2 is traveling or is in a stopped state, determine the duration T1, T2 based on the status information inputted via the first input interface, and cause the inverter 14 to control a rotation speed and a rotation direction of the electric motor 3 and perform the forward/rearward travel switching action over the determined duration T1, T2.

With the configuration of item 2, it is possible to determine the duration T1, T2 of the forward/rearward travel switching action depending on at least one of the state of the working vehicle 1 or the state of the surrounding environment of the working vehicle 1 while the vehicle body 2 is traveling or in the stopped state, and appropriately control the rapidity of the forward/rearward travel switching action of the working vehicle 1 using the determined duration T1, T2.

(Item 3) The working vehicle 1 according to item 1 or 2, further including a second input interface (forward/rearward travel switching lever 10, communicator 24) to receive input of an instruction to perform the forward/rearward travel switching action, wherein the controller 11 is configured or programmed to, upon receipt of input of the instruction, determine the duration T1, T2 based on the status information inputted via the first input interface, and perform the forward/rearward travel switching action over the determined duration T1, T2.

With the configuration of item 3, it is possible, when the instruction to perform the forward/rearward travel switching action is inputted via the second input interface 10, 24, to determine the duration T1, T2 of the forward/rearward travel switching action depending on at least one of the state of the working vehicle 1 or the state of the surrounding environment of the working vehicle 1, and appropriately control the rapidity of the forward/rearward travel switching action of the working vehicle 1 using the determined duration T1, T2.

(Item 4) The working vehicle 1 according to any one of items 1 to 3, wherein the controller 11 is configured or programmed to determine a point in time at which the forward/rearward travel switching action is to be performed based on the state of the at least one of the working vehicle 1 or the surrounding environment of the working vehicle 1 indicated by the status information, and, at the determined point in time, determine the duration T1, T2, and perform the forward/rearward travel switching action over the determined duration T1, T2.

With the configuration of item 4, it is possible, depending on the state of the working vehicle 1 and the surrounding environment, to automatically determine the point in time at which the forward/rearward travel switching action is to be performed and the duration T1, T2 of the forward/rearward travel switching action, appropriately perform the forward/rearward travel switching action at the determined point in time, and appropriately control the rapidity of the forward/rearward travel switching action using the duration T1, T2.

(Item 5) The working vehicle 1 according to any one of items 1 to 4, wherein the first input interface includes at least one of a user interface 20 to receive input of vehicle information indicating whether or not the working vehicle 1 is an unmanned working vehicle, a communicator 24 to receive the vehicle information, or a first sensor (person sensor) 21a to detect whether a person is in the working vehicle 1, the working vehicle 1 further includes at least one of a memory or a storage (memory) 11b to store the vehicle information, and the controller 11 is configured or programmed to determine whether or not a person is in the working vehicle 1 based on at least one of the vehicle information or a detected result from the first sensor 21a, and determine the duration T1, T2 such that the duration T1, T2 is shorter when it is determined that no persons are in the working vehicle than when it is determined that a person is in the working vehicle.

With the configuration of item 5, it is possible to, when no persons are in the working vehicle 1, perform the forward/rearward travel switching action relatively quickly for better responsivity, and when a person is in the working vehicle 1, perform the forward/rearward travel switching action relatively slowly for better stability of the working vehicle 1. Furthermore, when the forward/rearward travel switching action is performed slowly, it is possible to prevent or reduce the impact that would occur on the working vehicle 1.

(Item 6) The working vehicle according to any one of items 1 to 5, wherein the first input interface includes at least one of a second sensor 21b, 21d (steering angle sensor 21b, IMU 21d) to detect at least one of a steering angle of the vehicle body 2 or a yaw angle of the vehicle body 2, or a position detector 23 to detect a position thereof using a satellite positioning system, and the controller 11 is configured or programmed to determine whether the vehicle body 2 is traveling straight or turning based on at least one of a detected result from the second sensor 21b, 21d or time-series data about the position detected by the position detector 23, and determine the duration T1, T2 such that the duration T1, T2 is shorter when it is determined that the vehicle body 2 is traveling straight than when it is determined that the vehicle body 2 is turning.

With the configuration of item 6, it is possible to, when the working vehicle 1 is traveling straight, perform the forward/rearward travel switching action relatively quickly for better responsivity, and when the working vehicle 1 is turning, perform the forward/rearward travel switching action relatively slowly for better stability of the working vehicle 1.

(Item 7) The working vehicle 1 according to any one of items 1 to 6, wherein the first input interface includes at least one of a user interface 20 to receive input of device information relating to a working device 4 linked to the vehicle body 2 to perform work, a communicator 24 to receive the device information, or a third sensor 21e, 22a, 22c (load sensor 21e, laser sensor 22a, camera 22c) to detect the working device 4 linked to the vehicle body 2, the working vehicle 1 further includes at least one of a memory or a storage 11a to store the device information, and the controller 11 is configured or programmed to determine whether or not the working device 4 is linked to the vehicle body 2 based on at least one of a detected result from the third sensor 21e, 22a, 22c or the device information, and determine the duration T1, T2 such that the duration T1, T2 is shorter when it is determined that no working devices 4 are linked to the vehicle body 2 than when it is determined that the working device 4 is linked to the vehicle body 2.

With the configuration of item 7, it is possible to, when no working devices 4 are linked to the vehicle body 2, perform the forward/rearward travel switching action relatively quickly for better responsivity, and when a working device 4 is linked to the vehicle body 2, perform the forward/rearward travel switching action relatively slowly for better stability of the working vehicle 1.

(Item 8) The working vehicle 1 according to any one of items 1 to 7, wherein the first input interface includes at least one of a user interface 20 to receive input of device information relating to a working device 4 linked to the vehicle body 2 to perform work, a communicator 24 to receive the device information, or a third sensor 21e, 22a, 22c to detect the working device 4 linked to the vehicle body 2, the working vehicle 1 further includes at least one of a memory or a storage 11a to store the device information, and the controller 11 is configured or programmed to determine a type of the working device 4 liked to the vehicle body 2 based on at least one of a detected result from the third sensor 21e, 22a, 22c or the device information, and determine the duration T1, T2 based on the type of the working device.

With the configuration of item 8, it is possible to perform the forward/rearward travel switching action relatively quickly or relatively slowly depending on the type of the working device 4 linked to the vehicle body 2.

(Item 9) The working vehicle 1 according to item 8, wherein the controller 11 is configured or programmed to determine whether the type of the working device 4 is a directly attached working device supported by the vehicle body 2 or a towed working device towed by the vehicle body 2 based on at least one of the detected result from the third sensor 21e, 22a, 22c or the device information, and determine the duration T1, T2 such that the duration T1, T2 is shorter when it is determined that the type of the working device 4 is a directly attached working device than when it is determined that the type of the working device 4 is a towed working device.

With the configuration of item 9, it is possible to, when a directly attached working device 4 is linked to the vehicle body 2, perform the forward/rearward travel switching action relatively quickly for better responsivity, and when a towed working device 4 is linked to the vehicle body 2, perform the forward/rearward travel switching action relatively slowly for better stability of the working vehicle 1 and the working device 4.

(Item 10) The working vehicle 1 according to item 8 or 9, wherein the controller 11 is configured or programmed to determine whether the type of the working device 4 is a lightweight working device having a weight less than a threshold or a heavyweight working device having a weight equal to or more than the threshold based on at least one of the detected result from the third sensor 21e, 22a, 22c or the device information, and determine the duration T1, T2 such that the duration T1, T2 is shorter when it is determined that the type of the working device 4 is a lightweight working device than when it is determined that the type of the working device 4 is a heavyweight working device.

With the configuration of item 10, it is possible to, when a lightweight working device 4 is linked to the vehicle body 2, perform the forward/rearward travel switching action relatively quickly for better responsivity, and when a heavyweight working device 4 is linked to the vehicle body 2, perform the forward/rearward travel switching action relatively slowly for better stability of the working vehicle 1 and the working device 4.

(Item 11) The working vehicle 1 according to any one of items 8 to 10, wherein the controller 11 is configured or programmed to determine whether the working device 4 is linked to a front portion of the vehicle body 2 or a rear portion of the vehicle body 2 based on at least one of the detected result from the third sensor 21e, 22a, 22c or the device information, and determine the duration T1, T2 such that the duration T1, T2 is shorter when it is determined that the working device 4 is linked to the front portion of the vehicle body 2 than when it is determined that the working device 4 is linked to the rear portion of the vehicle body 2.

With the configuration of item 11, it is possible to, when a working device 4 is linked to a front portion of the vehicle body 2, perform the forward/rearward travel switching action relatively quickly for better responsivity, and when a working device 4 is linked to a rear portion of the vehicle body 2, perform the forward/rearward travel switching action relatively slowly for better stability of the working vehicle 1 and the working device 4.

(Item 12) The working vehicle 1 according to any one of items 1 to 11, wherein the first input interface includes at least one of a fourth sensor (IMU) 21d to detect a pitch angle of the vehicle body 2, a fifth sensor 22a, 22c (laser sensor 22a, camera 22c) to detect a slope condition of a ground on which the vehicle body 2 is located, or a communicator 24 to receive map information including a geographical feature of a location where the vehicle body 2 travels, the first input interface further includes a position detector 23 to detect a position thereof using a satellite positioning system, the working vehicle 1 further includes at least one of a memory or a storage 11a to store the map information, and the controller 11 is configured or programmed to determine at least one of a geographical feature or a size of a location where the vehicle body 2 is located based on at least one of a detected result from the fourth sensor 21d, a detected result from the fifth sensor 22a, 22c, or a result of comparison between the map information and the position detected by the position detector 23, and determine the duration T1, T2 based on the determined at least one of the geographical feature or the size of the location.

With the configuration of item 12, it is possible to perform the forward/rearward travel switching action relatively quickly or relatively slowly depending on at least one of the geographical feature(s) or the size of the location where the working vehicle 1 is traveling or stopping.

(Item 13) The working vehicle 1 according to item 12, wherein the controller 11 is configured or programmed to determine whether the vehicle body 2 is traveling on a level ground or a sloping ground based on at least one of the detected result from the fourth sensor 21d, the detected result from the fifth sensor 22a, 22c, or the result of comparison, and determine the duration such that the duration is shorter when it is determined that the vehicle body 2 is traveling on a level ground than when it is determined that the vehicle body 2 is traveling on a sloping ground.

With the configuration of item 13, it is possible to, when the working vehicle 1 is traveling on a level ground, perform the forward/rearward travel switching action relatively quickly for better responsivity, and when the working vehicle 1 is traveling on a sloping ground, perform the forward/rearward travel switching action relatively slowly for better stability of the working vehicle 1.

(Item 14) The working vehicle 1 according to item 12 or 13, wherein the controller 11 is configured or programmed to determine whether the vehicle body 2 is traveling up or down a sloping ground based on at least one of the detected result from the fourth sensor 21d, the detected result from the fifth sensor 22a, 22c, or the result of comparison, and determine the duration T1, T2 such that the duration T1, T2 is longer when it is determined that the vehicle body 2 is traveling up a sloping ground than when it is determined that the vehicle body 2 is traveling down a sloping ground.

With the configuration of item 14, it is possible to, when the working vehicle 1 is traveling down a sloping ground, perform the forward/rearward travel switching action relatively quickly for better responsivity, and when the working vehicle 1 is traveling up a sloping ground, perform the forward/rearward travel switching action relatively slowly for better stability of the working vehicle 1.

(Item 15) The working vehicle 1 according to any one of items 12 to 14, wherein the controller 11 is configured or programmed to determine whether the vehicle body is traveling on a level ground or traveling up a sloping ground based on at least one of the detected result from the fourth sensor 21d, the detected result from the fifth sensor 22a, 22c, or the result of comparison, and determine the duration T1, T2 such that the duration T1, T2 is shorter when it is determined that the vehicle body 2 is traveling on a level ground than when it is determined that the vehicle body 2 is traveling up a sloping ground.

With the configuration of item 15, it is possible to, when the working vehicle 1 is traveling on a level ground, perform the forward/rearward travel switching action relatively quickly for better responsivity, and when the working vehicle 1 is traveling up a sloping ground, perform the forward/rearward travel switching action relatively slowly for better stability of the working vehicle 1.

(Item 16) The working vehicle 1 according to any one of items 1 to 15, wherein the first input interface includes at least one of a user interface 20 to receive input of agricultural field information relating to an agricultural field H1, or a communicator 24 to receive the agricultural field information, the first input interface further includes a position detector 23 to detect a position thereof using a satellite positioning system, the working vehicle 1 further includes at least one of a memory or a storage 11a to store the agricultural field information, and the controller 11 is configured or programmed to, in a case that the position detected by the position detector 23 is in a headland E1 located between a work area C1 of the agricultural field H1 and an edge H2 of the agricultural field H1 indicated by the agricultural field information included in status information, calculate a headland width D2 which is a distance from the work area C1 to the edge H2, and determine the duration T1, T2 such that the duration T1, T2 is longer when the headland width D2 is less than a predetermined value than when the headland width D2 is equal to or more than the predetermined value.

With the configuration of item 16, it is possible to perform the forward/rearward travel switching action relatively quickly when the working vehicle 1 is located at the headland E1 having a large width, and possible to perform the forward/rearward travel switching action relatively slowly to eliminate or reduce the likelihood that the working vehicle 1 will deviate from the agricultural field H1 when the working vehicle 1 is located at the headland E1 having a small width.

(Item 17) The working vehicle 1 according to any one of items 1 to 16, wherein the controller 11 is configured or programmed to determine whether or not a predetermined condition is satisfied based on the status information, and determine a related value for use in determining the duration T1, T2 that is a first value or a second value depending on whether or not the predetermined condition is satisfied, the second value being a value that makes the duration T1, T2 longer than the first value.

With the configuration of item 17, it is possible to appropriately and easily determine the duration T1, T2 of the forward/rearward travel switching action based on predetermined condition(s) relating to at least one of the state of the working vehicle 1 or the state of the surrounding environment of the working vehicle 1.

(Item 18) The working vehicle 1 according to item 17, wherein the controller 11 is configured or programmed to determine whether or not a plurality of the predetermined conditions are satisfied based on a plurality of pieces of the status information, and provisionally determine, depending on whether or not the plurality of predetermined conditions are satisfied, a respective plurality of the related values each of which is the first value or the second value, and in a case that the provisionally determined plurality of related values include one or more instances of the first value and one or more instances of the second value, determine that the first value or the second value a number of the included instances of which is more than the other is a definitively determined related value.

With the configuration of item 18, even if the plurality of related values for use in determining a duration T1, T2 that are determined based on a plurality of predetermined conditions include both the first value and the second value, since one of the first and second values the number of instances of which is more than the other is selected, it is possible to determine the duration T1, T2 of the forward/rearward travel switching action suitable for the state of the working vehicle 1 and the surrounding environment. It is then possible to appropriately control the rapidity of the forward/rearward travel switching action of the working vehicle 1 using the determined duration T1, T2.

(Item 19) The working vehicle 1 according to item 17, wherein the controller 11 is configured or programmed to determine whether or not a plurality of the predetermined conditions are satisfied based on a plurality of pieces of the status information, and provisionally determine, depending on whether or not the plurality of predetermined conditions are satisfied, a respective plurality of the related values each of which is the first value or the second value, in a case that each of the provisionally determined plurality of related values is the first value, determine that the first value is a definitively determined related value, and in a case that the provisionally determined plurality of related values include one or more instances of the first value and one or more instances of the second value, determine that the second value is a definitively determined related value.

With the configuration of item 19, if the plurality of related values for use in determining a duration T1, T2 that are provisionally determined based on the plurality of predetermined conditions are all first values, it is possible to determine a short duration T1, T2 based on the first value and quickly perform the forward/rearward travel switching action of the working vehicle 1. If the plurality of related values include both the first value and the second value, it is possible to determine a long duration T1, T2 based on the second value and possible to slowly and stably perform the forward/rearward travel switching of the working vehicle 1.

(Item 20) The working vehicle 1 according to item 17, wherein the controller 11 is configured or programmed to determine whether or not a plurality of the predetermined conditions are satisfied based on a plurality of pieces of the status information, and provisionally determine, depending on whether or not the plurality of predetermined conditions are satisfied, a plurality of the related values each of which is the first value or the second value, assign N points to each of the plurality of related values that has been provisionally determined based on a dynamic condition included in the plurality of predetermined conditions, whether the dynamic condition is satisfied being variable during travel of the vehicle body, assign M points to each of the plurality of related values that has been provisionally determined based on a static condition included in the plurality of predetermined conditions, whether the static condition is satisfied being not variable during travel of the vehicle body, where M is less than N, and in a case that the provisionally determined plurality of related values include one or more instances of the first value and one or more instances of the second value, calculate a total number of points assigned to the one or more included instances of the first value and a total number of points assigned to the one or more included instances of the second value, and determine that the first value or the second value the total number of points of which is more than the other is a definitively determined related value.

With the configuration of item 20, even if the plurality of related values for use in determining a duration T1, T2 that are determined based on the plurality of predetermined conditions include both the first value and the second value, it is possible to use the first value or the second value that is suitable for the working vehicle 1 and the surrounding environment by prioritizing the related value(s) determined based on dynamic condition(s) over those determined based on (s)static condition, among the plurality of predetermined conditions. It is then possible to appropriately control the rapidity of the forward/rearward travel switching action of the working vehicle 1 using the duration T1, T2.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle comprising:
an electric motor in or on a vehicle body;
a traveling device to be driven by power from the electric motor to cause the vehicle body to travel;
a first input interface to receive input of status information indicating a state of at least one of the working vehicle or a surrounding environment of the working vehicle; and
a controller configured or programmed to determine, based on the status information, a duration of a forward/rearward travel switching action to change a direction of travel of the vehicle body from forward to rearward or from rearward to forward, and control driving of the electric motor to perform, via the traveling device, the forward/rearward travel switching action over the determined duration.

2. The working vehicle according to claim 1, further comprising an inverter to drive the electric motor; wherein
the controller is configured or programmed to, while the vehicle body is traveling or is in a stopped state, determine the duration based on the status information inputted via the first input interface, and cause the inverter to control a rotation speed and a rotation direction of the electric motor and perform the forward/rearward travel switching action over the determined duration.

3. The working vehicle according to claim 1, further comprising a second input interface to receive input of an instruction to perform the forward/rearward travel switching action; wherein
the controller is configured or programmed to, upon receipt of input of the instruction, determine the duration based on the status information inputted via the first input interface, and perform the forward/rearward travel switching action over the determined duration.

4. The working vehicle according to claim 1, wherein the controller is configured or programmed to determine a point in time at which the forward/rearward travel switching action is to be performed based on the state of the at least one of the working vehicle or the surrounding environment of the working vehicle indicated by the status information, and, at the determined point in time, determine the duration, and perform the forward/rearward travel switching action over the determined duration.

5. The working vehicle according to claim 1, wherein
the first input interface includes at least one of:
a user interface to receive input of vehicle information indicating whether or not the working vehicle is an unmanned working vehicle;
a communicator to receive the vehicle information; or
a first sensor to detect whether a person is in the working vehicle;
the working vehicle further comprises at least one of a memory or a storage to store the vehicle information; and
the controller is configured or programmed to:
determine whether or not a person is in the working vehicle based on at least one of the vehicle information or a detected result from the first sensor; and
determine the duration such that the duration is shorter when it is determined that no persons are in the working vehicle than when it is determined that a person is in the working vehicle.

6. The working vehicle according to claim 1, wherein
the first input interface includes at least one of:
a second sensor to detect at least one of a steering angle of the vehicle body or a yaw angle of the vehicle body; or
a position detector to detect a position thereof using a satellite positioning system; and
the controller is configured or programmed to:
determine whether the vehicle body is traveling straight or turning based on at least one of a detected result from the second sensor or time-series data about the position detected by the position detector; and
determine the duration such that the duration is shorter when it is determined that the vehicle body is traveling straight than when it is determined that the vehicle body is turning.

7. The working vehicle according to claim 1, wherein
the first input interface includes at least one of:
a user interface to receive input of device information relating to a working device linked to the vehicle body to perform work;
a communicator to receive the device information; or
a third sensor to detect the working device linked to the vehicle body;
the working vehicle further comprises at least one of a memory or a storage to store the device information; and
the controller is configured or programmed to:
determine whether or not the working device is linked to the vehicle body based on at least one of a detected result from the third sensor or the device information; and
determine the duration such that the duration is shorter when it is determined that no working devices are linked to the vehicle body than when it is determined that the working device is linked to the vehicle body.

8. The working vehicle according to claim 1, wherein
the first input interface includes at least one of:
a user interface to receive input of device information relating to a working device linked to the vehicle body to perform work;
a communicator to receive the device information; or
a third sensor to detect the working device linked to the vehicle body;
the working vehicle further comprises at least one of a memory or a storage to store the device information; and
the controller is configured or programmed to:
determine a type of the working device liked to the vehicle body based on at least one of a detected result from the third sensor or the device information; and
determine the duration based on the type of the working device.

9. The working vehicle according to claim 8, wherein the controller is configured or programmed to:
determine whether the type of the working device is a directly attached working device supported by the vehicle body or a towed working device towed by the vehicle body based on at least one of the detected result from the third sensor or the device information; and
determine the duration such that the duration is shorter when it is determined that the type of the working device is a directly attached working device than when it is determined that the type of the working device is a towed working device.

10. The working vehicle according to claim 8, wherein the controller is configured or programmed to:
determine whether the type of the working device is a lightweight working device having a weight less than a threshold or a heavyweight working device having a weight equal to or more than the threshold based on at least one of the detected result from the third sensor or the device information; and
determine the duration such that the duration is shorter when it is determined that the type of the working device is a lightweight working device than when it is determined that the type of the working device is a heavyweight working device.

11. The working vehicle according to claim 8, wherein the controller is configured or programmed to:
determine whether the working device is linked to a front portion of the vehicle body or a rear portion of the vehicle body based on at least one of the detected result from the third sensor or the device information; and
determine the duration such that the duration is shorter when it is determined that the working device is linked to the front portion of the vehicle body than when it is determined that the working device is linked to the rear portion of the vehicle body.

12. The working vehicle according to claim 1, wherein
the first input interface includes at least one of:
a fourth sensor to detect a pitch angle of the vehicle body;
a fifth sensor to detect a slope condition of a ground on which the vehicle body is located; or
a communicator to receive map information including a geographical feature of a location where the vehicle body travels;
the first input interface further includes a position detector to detect a position thereof using a satellite positioning system;
the working vehicle further comprises at least one of a memory or a storage to store the map information; and
the controller is configured or programmed to:
determine at least one of a geographical feature or a size of a location where the vehicle body is located based on at least one of a detected result from the fourth sensor, a detected result from the fifth sensor, or a result of comparison between the map information and the position detected by the position detector; and
determine the duration based on the determined at least one of the geographical feature or the size of the location.

13. The working vehicle according to claim 12, wherein the controller is configured or programmed to:
determine whether the vehicle body is traveling on a level ground or a sloping ground based on at least one of the detected result from the fourth sensor, the detected result from the fifth sensor, or the result of comparison; and
determine the duration such that the duration is shorter when it is determined that the vehicle body is traveling on a level ground than when it is determined that the vehicle body is traveling on a sloping ground.

14. The working vehicle according to claim 12, wherein the controller is configured or programmed to determine whether the vehicle body is traveling up or down a sloping ground based on at least one of the detected result from the fourth sensor, the detected result from the fifth sensor, or the result of comparison, and determine the duration such that the duration is longer when it is determined that the vehicle body is traveling up a sloping ground than when it is determined that the vehicle body is traveling down a sloping ground.

15. The working vehicle according to claim 12, wherein the controller is configured or programmed to determine whether the vehicle body is traveling on a level ground or traveling up a sloping ground based on at least one of the detected result from the fourth sensor, the detected result from the fifth sensor, or the result of comparison, and determine the duration such that the duration is shorter when it is determined that the vehicle body is traveling on a level ground than when it is determined that the vehicle body is traveling up a sloping ground.

16. The working vehicle according to claim 1, wherein
the first input interface includes at least one of:
a user interface to receive input of agricultural field information relating to an agricultural field; or
a communicator to receive the agricultural field information;
the first input interface further includes a position detector to detect a position thereof using a satellite positioning system;
the working vehicle further comprises at least one of a memory or a storage to store the agricultural field information; and
the controller is configured or programmed to:
in a case that the position detected by the position detector is in a headland located between a work area of the agricultural field and an edge of the agricultural field indicated by the agricultural field information, calculate a headland width which is a distance from the work area to the edge; and
determine the duration such that the duration is longer when the headland width is less than a predetermined value than when the headland width is equal to or more than the predetermined value.

17. The working vehicle according to claim 1, wherein the controller is configured or programmed to determine whether or not a predetermined condition is satisfied based on the status information, and determine a related value for use in determining the duration that is a first value or a second value depending on whether or not the predetermined condition is satisfied, the second value being a value that makes the duration longer than the first value.

18. The working vehicle according to claim 17, wherein the controller is configured or programmed to:
determine whether or not a plurality of the predetermined conditions are satisfied based on a plurality of pieces of the status information, and provisionally determine, depending on whether or not the plurality of predetermined conditions are satisfied, a respective plurality of the related values each of which is the first value or the second value; and
in a case that the provisionally determined plurality of related values include one or more instances of the first value and one or more instances of the second value, determine that the first value or the second value a number of the included instances of which is more than the other is a definitively determined related value.

19. The working vehicle according to claim 17, wherein the controller is configured or programmed to:
determine whether or not a plurality of the predetermined conditions are satisfied based on a plurality of pieces of the status information, and provisionally determine, depending on whether or not the plurality of predetermined conditions are satisfied, a respective plurality of the related values each of which is the first value or the second value;
in a case that each of the provisionally determined plurality of related values is the first value, determine that the first value is a definitively determined related value; and
in a case that the provisionally determined plurality of related values include one or more instances of the first value and one or more instances of the second value, determine that the second value is a definitively determined related value.

20. The working vehicle according to claim 17, wherein the controller is configured or programmed to:
determine whether or not a plurality of the predetermined conditions are satisfied based on a plurality of pieces of the status information, and provisionally determine, depending on whether or not the plurality of predetermined conditions are satisfied, a plurality of the related values each of which is the first value or the second value;
assign N points to each of the plurality of related values that has been provisionally determined based on a dynamic condition included in the plurality of predetermined conditions, whether the dynamic condition is satisfied being variable during travel of the vehicle body;
assign M points to each of the plurality of related values that has been provisionally determined based on a static condition included in the plurality of predetermined conditions, whether the static condition is satisfied being not variable during travel of the vehicle body, where M is less than N; and
in a case that the provisionally determined plurality of related values include one or more instances of the first value and one or more instances of the second value, calculate a total number of points assigned to the one or more included instances of the first value and a total number of points assigned to the one or more included instances of the second value; and
determine that the first value or the second value the total number of points of which is more than the other is a definitively determined related value.
